(19) United States
(12) Patent Application Publication
(10) Pub. No.: US 2005/0251513 A1
(43) Pub. Date: Nov. 10, 2005

(54) Techniques for correlated searching through disparate data and content repositories

(76) Inventor: Rene Tenazas, Upper Saddle River, NJ (US)

Correspondence Address: Choate, Hall & Stewart;Patent Group, Exchange Place, 53 State Street, Boston, MA, 02109-2804, US

(21) Appl. No.: 11/096,713

(22) Filed: Apr. 1, 2005

Related U.S. Application Data
(60) Provisional application No. 60/559,681, filed on Apr. 5, 2004.
(60) Provisional application No. 60/579,468, filed on Jun. 14, 2004.

(51) Int. Cl. G06F 17/30

(52) U.S. Cl. 707/3

(57) ABSTRACT

Disclosed are a method, system, and computer program product for automatically performing data operations. A request and one of a template or an identifier for said template is received. The template specifies at least a first set of previously recorded data and a second set of previously recorded data. The first set of previously recorded data describes a first data source, first operation data, and first result structure data. The first operation data describes at least one criterion used in performing a first data operation on said first data source and producing first results in accordance with said first result structure data. The second set of previously recorded data describes a second data source, second operation data, and second result structure data. The second operation data is used in performing a second data operation on said second data source and producing second results in accordance with said second result structure data. The second operation data specifies a data element included in said first results. The second results is dependent upon said first results. In response to receiving said request, processing operations are performed in accordance with said template producing final results in accordance with at least one of said first results and said second results.

### RELATED APPLICATIONS

This application claims priority to Attorney Docket No. DWS-00160, U.S. Provisional Patent Application No. 60/559,681, filed on Apr. 5, 2004, entitled “Method for maintaining collections of generated web forms that are hyperlinked by subject”, and Attorney Docket No. DWS-00260, U.S. Provisional Patent Application No. 60/579,468, filed Jun. 14, 2004, entitled “Method for correlating searching through disparate data and content repositories”, both of which are incorporated by reference herein.

### BACKGROUND

1. Technical Field

This application generally relates to document management, and more particularly to techniques for maintaining and searching documents.

2. Description of Related Art

Electronically stored information may be included in different documents of varying types. One task that may be performed upon a set of electronically stored information, such as a set of documents, is to search the documents to determine ones of interest in accordance with user search criteria. One approach may include a user examining each document for relevant content such as, for example, by manually opening each document using the appropriate software. Such an approach may be cumbersome and very time consuming. Information about the content of a document may be discerned, for example, by the document title, or indexing of words therein. Thus, a search engine may also be used to query the set of documents to determine ones of interest. However, this may result in obtaining search results with a lot of additional irrelevant information. Furthermore, not all electronically stored information may be accessed using the search engine or other single software program. Documents stored in the form of HTML pages, for example, may also include hyperlinks which, when selected such as by clicking with a mouse, connect a user to another page or document with additional information. As part of drilling down through the displayed information via a browser, the user may traverse all such hyperlinks. Although the hyperlink may not lead to information of particular relevance to a user, the user must traverse the connecting links and examine the resulting hyperlinked page of information to make this determination.

Thus, it may be desirable to provide an efficient technique for maintaining, identifying, and linking electronically stored information that is related. It may also be desirable that this technique be applicable for use with electronically stored information included in a variety of different disparate forms.

### SUMMARY OF THE INVENTION

In accordance with one aspect of the invention is a method for automatically performing data operations comprising: receiving a request and one of a template or an identifier for said template, said template specifying at least a first set of previously recorded data and a second set of previously recorded data, said first set of previously recorded data describing a first data source, first operation data, and first result structure data, said first operation data describing at least one criterion used in performing a first data operation on said first data source and producing first results in accordance with said first result structure data, said second set of previously recorded data describing a second data source, second operation data, and second result structure data, said second operation data being used in performing a second data operation on said second data source and producing second results in accordance with said second result structure data, wherein said second operation data specifies a data element included in said first results, said second results being dependent upon said first results; and in response to receiving said request, performing processing operations in accordance with said template producing final results in accordance with at least one of said first results and said second results. The method may also include saving said first results and second results as an aggregate result, wherein said aggregate result comprises two data tables included in an XML file. At least one of said first data operation and said second data operation may use a software application to access, respectively, one of said first data source and said second data source. The step of performing processing operations may be performed by a query formulator engine, and the method may further comprises: invoking said query formulator passing one of said template, or an identifier of said template, as a parameter. The invoking may be performed in accordance with a scheduled operation by a scheduler making said request. The first data operation may be different from said second data operation. The first data operation may be a first query, said first operation data may specify search criteria used in performing said first query and produce said first results in accordance with results of said first query, said second data operation may be a second query, said second operation data may specify search criteria used in performing said second query and producing said second results in accordance with results of said second query. The final results may include data based on at least two of: said first data source, said second data source, said first results and said second results. The template may include a computation operating on data from at least one of said first results and said second results. The method may also include: accessing at least one of said first and said second data sources using an adaptor, said adaptor: invoking an application to access said at least one of said first and second data sources; and performing any data mapping to facilitate interfacing between said application and said query engine. The first data source and said second data source may be disparate data source types. The at least one of said first data source and said second data source may be a structured data source and the other of said data sources may be one of: an unstructured data source or a software application management system for unstructured content. The method may also include recording said first set of previously recorded data and said second set of previously recorded data during creating of a first subject record including a collection of data about a subject. The method may also include performing processing to place said first results in a format in accordance with said first result structure data and to place said second results in a format in accordance with said second result structure data; aggregating said first results and said second results in accordance with said formats in a result pool; passing the result pool to a component. The component may have caused said invoking of said query engine. The result pool may be one of: an XML stream, a set of database tables or a file which is passed to an application for further processing to produce said final results. The template may include “n” previously recorded data sets, “n” being greater than two, each of said “n” previously recorded data sets including information describing an “nth” data source, “nth” operation data, and “nth” result structure data, said “nth” operation data being used in performing an “nth” data operation on said “nth” data source and producing “nth” results in accordance with said “nth” result structure data, wherein said “nth” operation data specifies a data element included from a results associated with any one of said “n-1” previously recorded data sets.

In accordance with another aspect of the invention is a system comprising: a template specifying at least a first set of previously recorded data and a second set of previously recorded data, said first set of previously recorded data describing a first data source, first operation data, and first result structure data, said first operation data describing at least one criterion used in performing a first data operation on said first data source and producing first results in accordance with said first result structure data, said second set of previously recorded data describing a second data source, second operation data, and second result structure data, said second operation data being used in performing a second data operation on said second data source and producing second results in accordance with said second result structure data, wherein said second operation data specifies a data element included in said first results, said second results being dependent upon said first results; a requester issuing a request including said template or an identifier for said template; and a query formulator engine which receives said request and, in response, performs processing operations in accordance with said template producing final results in accordance with at least one of said first results and said second results. The system may also include an adapter for each of said first and said second data sources to facilitate obtaining data from each of said data sources.

In accordance with another aspect of the invention is a method for automatically performing data operations comprising: recording a first set of recorded data for a first query performed on a first data source producing first results; recording a second set of recorded data for a second query performed on a second data source producing second results, said second query including a query term which is dependent on a data element included in said first results, said second set of recorded data including a reference to said data element in said first results; producing first final results in accordance with at least one of said first results and said second results; and saving said first set of recorded data and said second set of recorded data in a template, said template being used in connection with reperforming said first and second queries on current instances of said data sources at a later point in time producing second final results in response to a single request.

In accordance with another aspect of the invention is a computer program product for automatically performing data operations comprising code that: receives a request and one of a template or an identifier for said template, said template specifying at least a first set of previously recorded data and a second set of previously recorded data, said first set of previously recorded data describing a first data source, first operation data, and first result structure data, said first operation data describing at least one criterion used in performing a first data operation on said first data source and producing first results in accordance with said first result structure data, said second set of previously recorded data describing a second data source, second operation data, and second result structure data, said second operation data being used in performing a second data operation on said second data source and producing second results in accordance with said second result structure data, wherein said second operation data specifies a data element included in said first results, said second results being dependent upon said first results; and in response to receiving said request, performs processing operations in accordance with said template producing final results in accordance with at least one of said first results and said second results.

In accordance with another aspect of the invention is a computer program product for automatically performing data operations comprising code that: records a first set of recorded data for a first query performed on a first data source producing first results; records a second set of recorded data for a second query performed on a second data source producing second results, said second query including a query term which is dependent on a data element included in said first results, said second set of recorded data including a reference to said data element in said first results; produces first final results in accordance with at least one of said first results and said second results; and saves said first set of recorded data and said second set of recorded data in a template, said template being used in connection with reperforming said first and second queries on current instances of said data sources at a later point in time producing second final results in response to a single request.

In accordance with another aspect of the invention is a method for linking related data records comprising: selecting an element from a user interface, said user interface displaying data associated with a first record, said first record representing an instance of a collection of data about a first subject; issuing a request in response to said selecting, said request specifying a second subject and a key value, said key value used in identifying a related record from other records associated with said second subject; receiving said request; searching a collection of data using search criteria including said second subject and said key value to identify said related record in said collection; and returning a response including data corresponding to said related record. The element may be a hyperlink of a displayed page. The method may also include invoking a subject search engine in response to said request passing said second subject and said key value as parameters. The method may also include: determining, from said collection of data, a template associated with said second subject; determining one or more records associated with said template, each of said one or more records associated with said template having been generated in accordance with data included in said template; and determining, from said one or more records, said related record matching said key value. The related record may have a first timestamp indicating when said related record was generated which is later than a second timestamp associated with said first record. The template may be a default template, and the method may include: selecting said default template from a plurality of templates associated with said second subject. The method may also include returning with said response a list specifying at least a portion of said plurality of templates. The method may include: displaying said list; and selecting a second template from said list; searching, in response to said selecting said second template, said collection of data for a record associated with said second template; and returning in a response data corresponding to said record associated with said second template. A plurality of records may match said subject and said key value, and the method may further comprise: returning with said response a list specifying at least a portion of said plurality of records. A plurality of records may match said subject and said key value, and the method may further comprise selecting a default record from said plurality of records, said default record being a predetermined version of a collection of data. The default record is a latest version of said plurality of records. Each of said plurality of records may correspond to a report generated at a point in time in accordance with at least one of a report generation schedule and an event occurrence.

In accordance with another aspect of the invention is a method for linking a first record associated with a first subject with a related record associated with a second subject comprising: receiving a template used in generating records associated with said first subject, said template including first data used in defining a hyperlink included in one of said generated records, said hyperlink which, when selected, causes invocation of program which is passed parameters identifying said second subject and including a value of a key, said program identifying said related record as a result of said invocation in accordance with said second subject and said value of said key; and generating said first record using said template, said first record including said parameters generated in accordance with said first data, said first record including said hyperlink when displayed. The method may include generating said template while recording data during creation of an initial record associated with said first subject. The method may include using said template to create another subject record at a later point in time after creation of said initial record. The first record and said related record may be web forms. The related record may be created at a point in time after said first record is generated. The method may also include: displaying said first record; selecting said hyperlink; issuing a request in response to said selecting, said request including said parameters; invoking said program in response to said request; and returning, in response to said request, said related record.

In accordance with another aspect of the invention is a system for linking related records comprising: a subject search engine which searches a collection of data and identifies a record in accordance with searching criteria, said searching criteria including a subject and a value of a key; a template used in generating records associated with a first subject, said template including first data used in defining a hyperlink which, when selected, causes invocation of said subject search engine which is passed parameters identifying a second subject and including a value of a key, said subject search engine identifying a related record as a result of said invocation; and a generator that generates said first record using said template, said first record including said parameters generated in accordance with said first data, said first record including said hyperlink when displayed.

In accordance with another aspect of the invention is a method for linking a first record associated with a first subject with a related record associated with a second subject comprising: recording information while performing steps in connection with generation of a first record, said information including first data used in defining a hyperlink included in said first record, said hyperlink which, when selected, causes invocation of program which is passed parameters identifying said second subject and including a value of a key, said program identifying said related record as a result of said invocation in accordance with said second subject and said value of said key; and storing said information in a template, said template used in generating a second record at a later point in time, said second record including a definition of a second hyperlink to another related record, said second record including parameters generated in accordance with said first data, said second record including said second hyperlink when displayed.

In accordance with another aspect of the invention is a computer program product for linking related data records comprising code that: selects an element from a user interface, said user interface displaying data associated with a first record, said first record representing an instance of a collection of data about a first subject; issues a request in response to said selecting, said request specifying a second subject and a key value, said key value used in identifying a related record from other records associated with said second subject; receives said request; searches a collection of data using search criteria including said second subject and said key value to identify said related record in said collection; and returns a response including data corresponding to said related record.

In accordance with another aspect of the invention is a computer program product for linking a first record associated with a first subject with a related record associated with a second subject comprising code that: receives a template used in generating records associated with said first subject, said template including first data used in defining a hyperlink included in one of said generated records, said hyperlink which, when selected, causes invocation of program which is passed parameters identifying said second subject and including a value of a key, said program identifying said related record as a result of said invocation in accordance with said second subject and said value of said key; and generates said first record using said template, said first record including said parameters generated in accordance with said first data, said first record including said hyperlink when displayed.

In accordance with another aspect of the invention is a computer program product for linking a first record associated with a first subject with a related record associated with a second subject comprising code that: records information while performing steps in connection with generation of a first record, said information including first data used in defining a hyperlink included in said first record, said hyperlink which, when selected, causes invocation of program which is passed parameters identifying said second subject and including a value of a key, said program identifying said related record as a result of said invocation in accordance with said second subject and said value of said key; and stores said information in a template, said template used in generating a second record at a later point in time, said second record including a definition of a second hyperlink to another related record, said second record including parameters generated in accordance with said first data, said second record including said second hyperlink when displayed.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a computer system that may utilize the techniques described herein;

FIG. 2 is an example of an embodiment of the components that may be included in a host and/or server of FIG. 1;

FIG. 3 is an example of a screen shot of a subject record;

FIG. 4 is an example illustrating use of hyperlinks between related subject records;

FIGS. 5 and 6 are example screen shots displaying related subject records linked via hyperlink;

FIGS. 7 and 8 are example of screen shots that may be used in connection with defining subjects and related subject keys;

FIG. 9 is an example representation of elements that may be included in a template;

FIG. 10 is an example of components that may used in connection with generation of a template and subject record;

FIGS. 11 and 12 are example screen shots that may be included in an embodiment in connection with defining a template;

FIGS. 13-15 illustrate processing performed in an embodiment in performing a correlated searching;

FIG. 16 is an example of an embodiment of components used in connection with performing the correlated searching;

FIG. 17 is an example representation of a portion of a template in connection with the correlated searching sources and outputs;

FIGS. 18 and 19 are flowcharts of processing steps that may be performed in an embodiment for performing correlated searching;

FIG. 20 illustrates a more detailed example of portions of a template file and data in connection with a correlated search;

FIG. 21 is an illustration of an example relating hyperlinking between subject records and the particular structures representing this relationship;

FIGS. 22 through 27 are example screenshots used to illustrate defining a hyperlink utilizing the techniques described herein invoking a subject search engine;

FIG. 28 is an example of components that may be included in the server system in performing the techniques described herein;

FIGS. 29 and 30 are flowcharts summarizing processing steps that may be performed in connection with generation of the template and subject record in an embodiment;

FIG. 31 is an example representation of structures that may be included in a system database;

FIGS. 32-34 are flowcharts of processing steps that may be performed in an embodiment in connection with performing the subject search upon invocation via a hyperlink; and

FIG. 35 is an example illustrating the data flow in connection with the subject search engine performing the subject search.

### DETAILED DESCRIPTION OF EMBODIMENT(S)

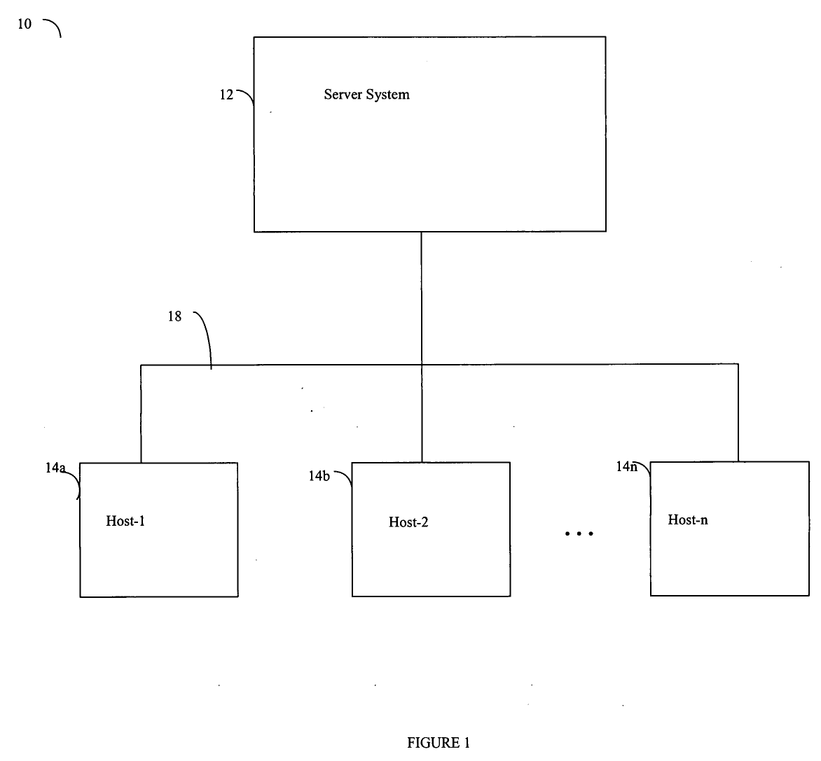

Referring now to FIG. 1, shown is an example of an embodiment of a computer system that may bemused in connection with performing the techniques described herein. The computer system 10 includes a sever system 12 connected to host systems 14a-14n through communication medium 18. In this embodiment of the computer system 10, and the N hosts 14a-14n may issue requests to the server system 12, for example, in performing input/output (I/O) operations or data requests. The communication medium 18 may be any one or more of a variety of networks or other type of communication connections as known to those skilled in the art. The communication medium 18 may be a network connection, bus, and/or other type of data link, such as a hardwire or other connections known in the art. For example, the communication medium 18 may be the Internet, an intranet, network or other wireless or other hardwired connection(s) by which the host systems 14a-14n may access and communicate with the server system 12, and may also communicate with others included in the computer system 10.

Each of the host systems 14a-14n and the server system 12 included in the computer system 10 may be connected to the communication medium 18 by any one of a variety of connections as may be provided and supported in accordance with the type of communication medium 18. The processors included in the host computer systems 14a-14n and server system 12 may be any one of a variety of proprietary or commercially available single or multi-processor system, such as an Intel-based processor, or other type of commercially available processor able to support traffic in accordance with each particular embodiment and application.

Each of the host computers 14a-14n and server system may all be located at the same physical site, or, alternatively, may also be located in different physical locations. Examples of the communication medium that may be used to provide the different types of connections between the host computer systems and the server systems may use a variety of different communication protocols such as SCSI, Fibre Channel, iSCSI, and the like. Some or all of the connections by which the hosts and server system may be connected to the communication medium may pass through other communication devices, such as a switching equipment that may exist such as a phone line, a repeater, a multiplexer or even a satellite.

Each of the host computer systems may perform different types of data operations in accordance with different types of tasks. In the embodiment of FIG. 1, any one of the host computers 14a-14n may issue a request to the server system 12 such as, for example, a request for a document with a particular URL referencing the server system 12. The request may result in a document, such as an HTML document, being sent from the server system 12 to a requesting host.

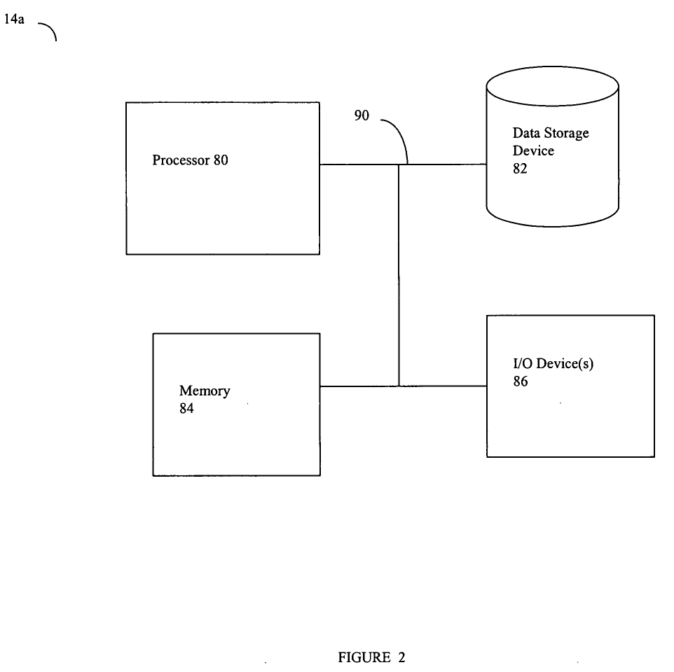

Referring now to FIG. 2, shown is an example of an embodiment of a host or user system 14a. It should be noted that although a particular configuration of a host system is described herein, other host systems 14b-14n, as well as one or more computers included in the server 12, may also be similarly configured. Additionally, it should be noted that each host system 14a-14n and one or more computers in the server 12 may have any one of a variety of different configurations including different hardware and/or software components. Included in this embodiment of the host system 14a is a processor 80, a memory, 84, one or more I/O devices 86 and one or more data storage devices 82 that may be accessed locally within the particular host system. Data may be stored, for example, on magnetic, optical, or silicon-based media. The particular arrangement and configuration of data storage devices may vary in accordance with the parameters and requirements associated with each embodiment. Each of the foregoing may communicate using a bus or other communication medium 90. Each of the foregoing components may be any one of more of a variety of different types in accordance with the particular host system 14a.

Computer instructions may be executed by a processor 80 of a host system to perform a variety of different operations, such as for a Web browser application to display an HTML page, handle user I/O, communicate with the server system, and the like. As known in the art, executable code may be produced, for example, using a loader, a linker, a language processor, and other tools that may vary in accordance with each embodiment. Computer instructions and data may also be stored on a data storage device 82, ROM, or other form of media or storage. The instructions may be loaded into memory 84 and executed by processor 80 to perform a particular task. In one embodiment, the host or user system 14a may include a browser which is used in connection with communicating with the server system 12, and displaying requested HTML pages returned from the server system to the requesting user.

Computer processors included in the server system 12 may be used to execute instructions implementing the techniques and functionality described herein as will be set forth in following paragraphs.

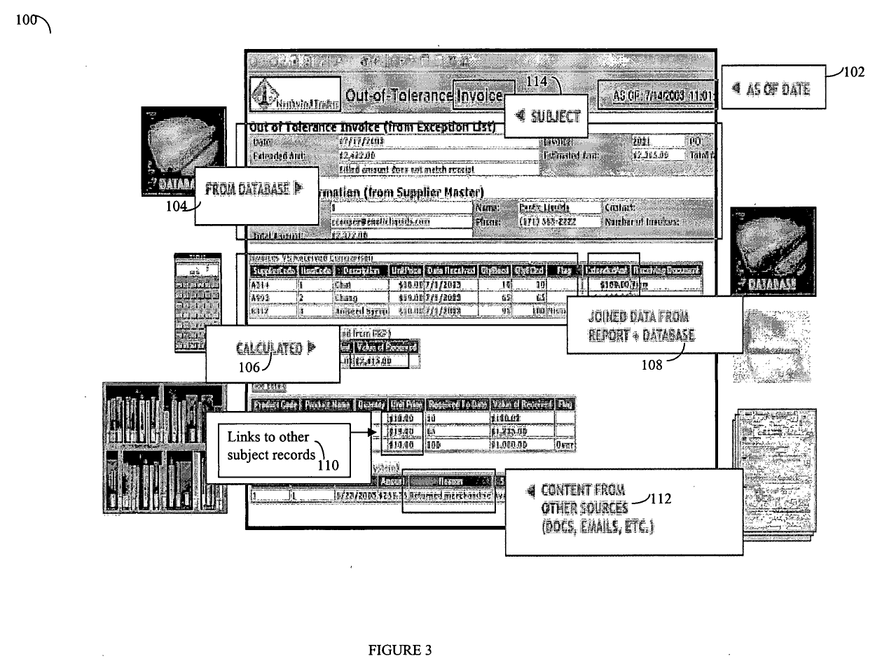

A user on a host system may issue a request for a page, such as an HTML page. The example 100 of FIG. 3 may be the displayed result, for example, of a browser or other software component processing the requested HTML page.

Referring now to FIG. 3, shown is an example screen shot of a subject record. As described elsewhere herein, a subject may be characterized as any topic a user may want information about in order to make a decision, accomplish a task, and the like. Subjects may include, for example, customer, vendor, order, product, recipe, payment, location, account, and the like.

A subject record may be characterized as an instance of collected data about a subject at a particular point in time. The subject record may include a collection of correlated facts about a subject based on one or more data sources. The data sources may be disparate. The example 100 is a sample subject record detailing sources of data from which information may be derived about the subject 114. The data included in the sample record 100 refers to an instance of the collected data from one or more sources with respect to a particular time or time stamp as illustrated, for example, by the “as of date” field 102. The data for this sample record 100 is based on four particular data sources which are disparate. The data sources used in producing the record 100 include data from a database 104, data joined from a report and a database in combination 108, and content from other sources which may be characterized as unstructured such as data from native files, e-mails and the like. The data from the database 104 may include one or more fields of data extracted from a particular database. The joined data as represented by element 108 in this example 100 is a table which includes data from two sources, a report such as an Excel spreadsheet, and another database. Data element 108 is an example of single table within a subject record in which the table combines data from disparate data sources. In element 108, the disparate data sources are a database and data from a report such as, for example, an Excel spreadsheet. Data sources used in producing the subject record 100 may also come from other sources as represented by 112. These other sources may include, for example, unstructured sources as described elsewhere herein.

Those data sources may be disparate data sources associated with any one or more different types of structured or unstructured data types. The data sources used in an embodiment with the techniques described herein may include and address any one of a variety of different types of data sources. The particular data source types supported may vary with each embodiment. The data sources may include both structured and unstructured data sources as well as data used by content management systems and document management systems. Data sources may include, for example, data from a database, data included in a file which is of a type of a native file system, e-mail messages, data associated with a word processing or other application, a report generated by a particular application, a file managed by a document management system, and the like.

Additionally illustrated in the subject record 100 are calculated values 106. Calculated values may be characterized as derived values based directly or indirectly on data from one or more data sources. A calculated value may also depend on another intermediate or calculated value as well as a particular data value included in one of the data sources. Data included in the subject records may be organized in a variety of different representations, for example, such as the joined result illustrated by element 108. The data which is joined may be included from one or more sources that may or may not be disparate. Data which is “joined” into a single representation included in 100 may be from different sources having a common key or field value. For example, data from source 1 may include records with field 1 values. Data from source 2 may include records also having defined field 1 values. A record from source 1 may be combined or “joined” with a record from source 2 in accordance with common field 1 values.

The illustrated subject record 100 also includes links 110 to other related subject records. As described elsewhere herein, a link 110 may be, for example, a hyperlink connecting a subject record 100 to another subject record. The links 110 to other subject records may be characterized as representing related references to other instances (e.g., subject records) of subjects. The links 110 representing hyperlinks to related references allow readers or viewers of a subject record such as 100 to find out more information about a referenced subject by clicking or selecting the particular link 110 included in 100.

The process for defining a hyperlink linking related subject records and other steps in producing the resulting subject record are described in more detail in following paragraphs. Selection of the hyperlink 110 in the subject record to link to another related subject record triggers execution of a subject search engine. The subject search engine may be used in determining the other related subject record which is returned to the user for display via the user's browser. The subject search engine and other components may be included in, and execute upon, the server system 12 of FIG. 1. The components and related processing performed when a user selects the hyperlink for the subject search are also described in more detail elsewhere herein.

The hyperlink as illustrated in connection with figures herein is used to facilitate linking related subject records. In one embodiment as described above, the selection of such a hyperlink may result in invocation of the subject search engine. However, other embodiments may use variations of the techniques described herein in connection with linking related subject records.

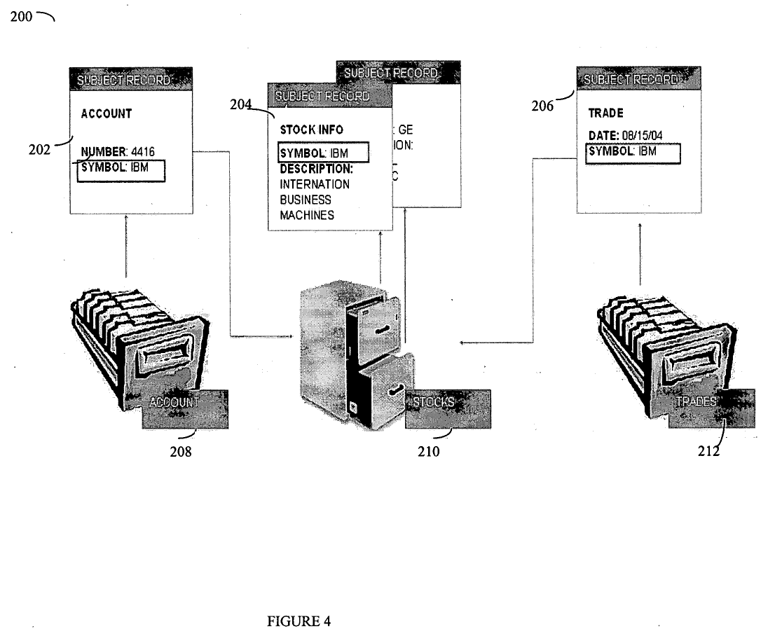

Referring now to FIG. 4, shown is an example 200 illustrating how one or more subject records may reference other subject records. It should be noted that the example 200 includes a representation of the subject record, for example, as illustrated in the example 100 of FIG. 3. The representation included in FIG. 4 for the subject records 202, 204 and 206 is a simplified representation of a subject record. In the example 200, a subject may be defined for account 208, stocks 210, and trades 212. Subject record 202 represents an instance of a record for the subject account 208. Similarly, subject record 204 represents an instance of a record for a subject of stocks, and subject record 206 represents an instance of a record for a subject of the type trades 212. The example 200 illustrates that each of the subject records 202, 204 and 206 may include a hyperlink defining a reference to a symbol for IBM. Thus, a user may be linked to a subject record for the symbol IBM upon selection of the hyperlink from one of the subject records 202, 204 or 206.

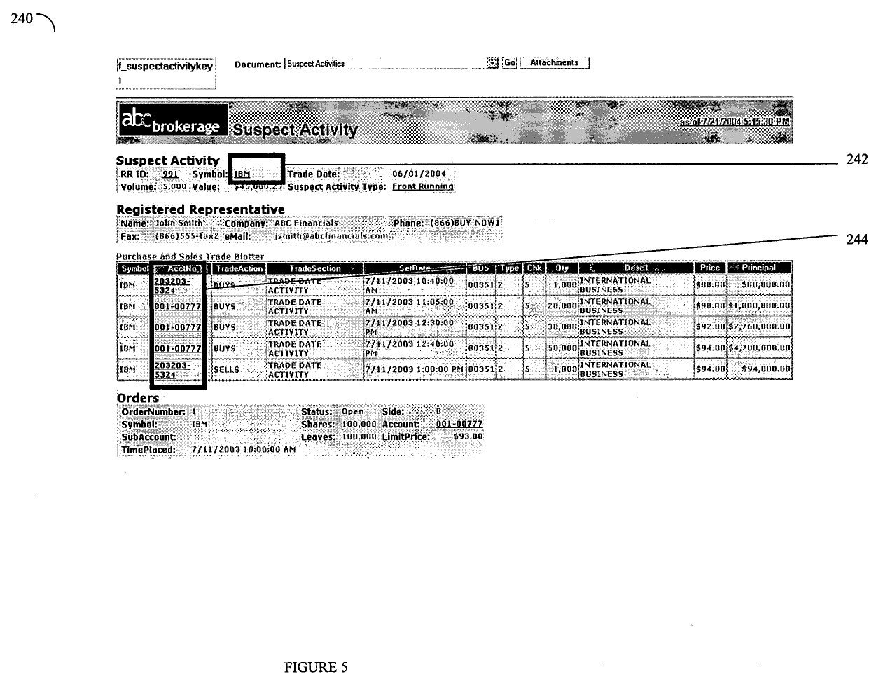

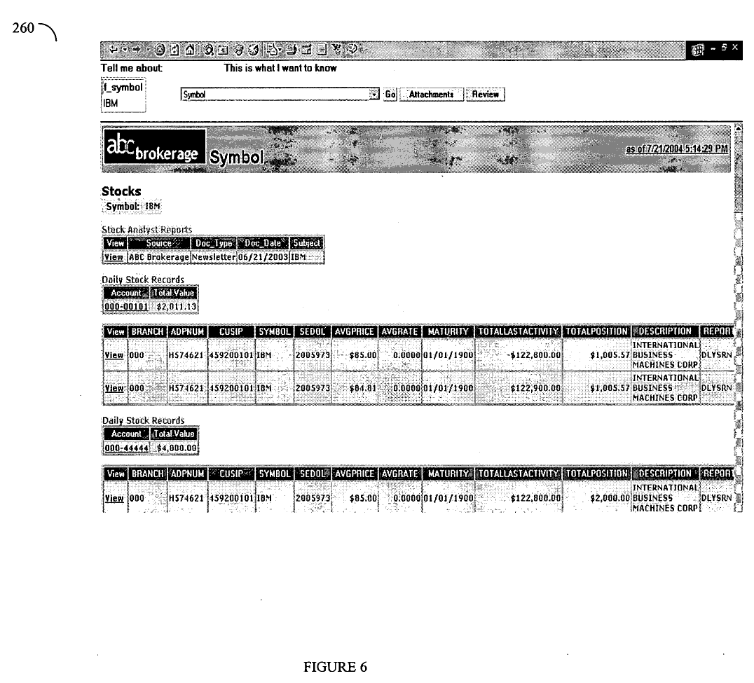

Referring now to FIG. 5, shown is an example 240 of a subject record for a subject compliance violations. The example 240 includes a hyperlink or reference 242 to the symbol IBM and a hyperlink as indicated by 244 for each of the accounts involved. In other words, each of the records included in 244 may represent a hyperlink which, when selected, displays information about each of the account numbers (e.g., “AcctNo” column 244). Upon selecting the hyperlink in 242 or the hyperlink corresponding to the symbol IBM in any of the subject records illustrated in the example 200 of FIG. 4, the subject record 260 may be displayed as illustrated in FIG. 6.

What will now be described and illustrated are processing steps and associated screen shots that may be displayed in connection with creating a new subject. Subject records, such as illustrated in FIG. 3, are an instance of a subject. A new subject may be defined, for example, by an administrator of a system including components performing the functionality described herein. The subjects and associated information described in following paragraphs may be performed as a first set of processing steps prior to generating a subject record utilizing the techniques described herein.

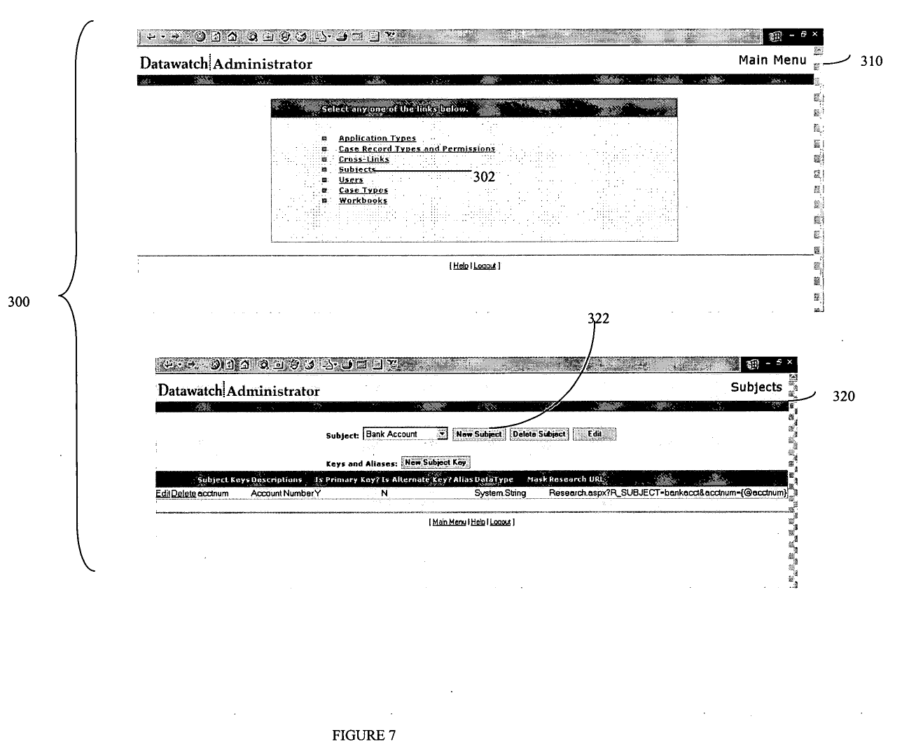

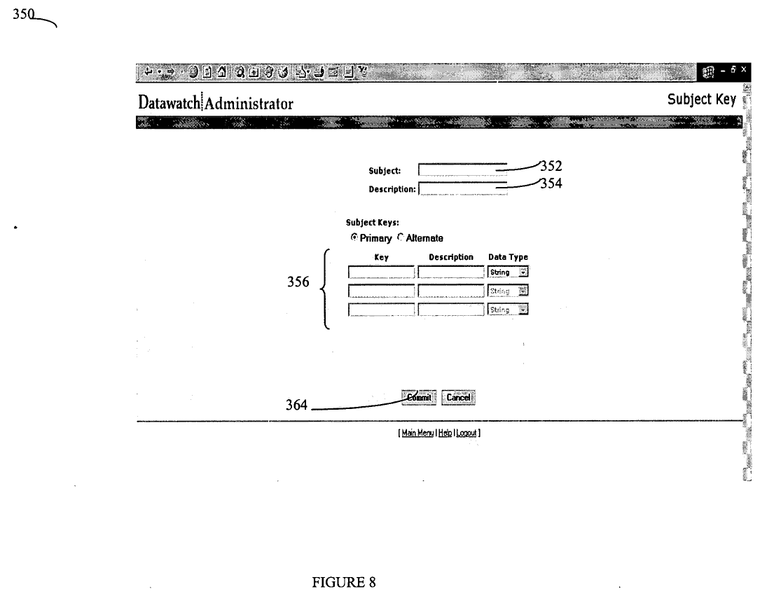

Referring now to FIG. 7, shown is an example 300 of a first set of screen shots that may be displayed in connection with creating a new subject. The screen shot 310 illustrates a main menu that may be displayed with one or more administrator functions. By selection of element 302 such as, for example, by clicking with a button on a mouse, screen shot 320 may subsequently be displayed. Screen shot 320 includes a new subject button 322 which may be selected in connection with creation of a new subject. Selection of the button 322 may result in display of screen shot 350 of FIG. 8.

Referring now to FIG. 8, shown is an example of another screen shot 350 that may be displayed in connection with creation of a new subject. The user may then proceed to enter information into the different input fields in the screen 350. The name of the subject may be entered into field 352. The subject name entered into field 352 may be, for example, something easily identifiable and associated with a particular subject matter. The description in field 354 may be, for example, text providing a description of the subject. Area 356 includes entries defining keys associated with the subject. It should be noted that data entered in connection with 356 may be used to uniquely define a particular subject. A combination of one or more keys entered into the key field of 356 may be used in searching and performing other operations herein to uniquely identify this particular subject of a particular data type. The data type may be, for example, string, numeric, date, decimal and the like, in accordance with a particular data types that may be available in an embodiment. After all of the information in screen shot 350 has been entered, a user may select the commit option 364 causing this particular subject key and associated definitions to be entered into the database.

It should be noted that in an embodiment with versioning, as described elsewhere herein in more detail, the values of a subject, associated subject key(s), and timestamp or other identifier corresponding to a particular version of a subject record may be used to uniquely identify a particular subject record from other subject records.

Once subjects and associated subject keys are defined, processing steps may be performed for generation of an initial subject record and associated template. What will now be described are illustrations of an embodiment for defining a template and generating an initial subject record. The template may be used in connection with generating subject records or instances of subjects in addition to the initial subject record. The user's steps in connection with creation of the initial subject record may be recorded causing creation of the template file. The template may be used in connection with generating additional subject records in an automated fashion.

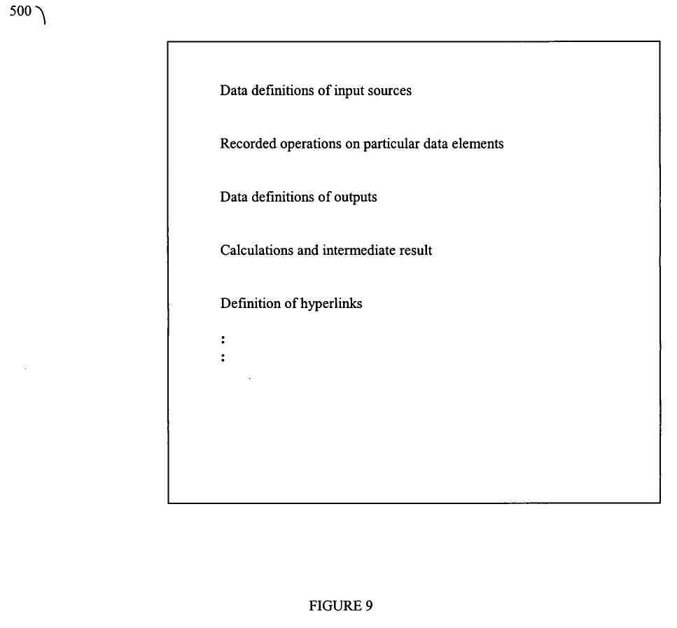

Referring now to FIG. 9, shown is an example representation 500 of a template including data, for example, as a result of executing steps in connection with defining a template associated with a subject. As part of recording the particular steps taken by a user in connection with generation of a subject record, an output file referred to herein as a template may be created which includes the elements illustrated in 500. As will be described in more details elsewhere herein, the template 500 may be used as an input to a program or other component as may vary in accordance with each embodiment in order to replay the steps as taken by a user in connection with creation of a subject record associated with the template. In other words, each time a user wishes to generate a new subject record associated with a particular template and subject, the template 500 generated previously may be read in by a program, such as a program written in the C# or other programming language, to generate a subject record. The template as illustrated by 500 may include data definitions of the input sources, recorded operations on particular data elements, data definitions of outputs, data definitions for intermediate results and representing calculations, definitions of hyperlinks, and the like. In other words, the data that is included in 500 is used in defining, for example, the particular data elements or a portion of the data sources used in connection with processing, the operations performed on the selected data elements, and the like. The particular operations performed on the data elements may be represented in any one or more different formats and embodiments. For example, in one embodiment the template as illustrated in 500 may be in the form of an XML file. The particular calculations and operations that may be performed on the data elements may vary with each embodiment and the particular way in which the calculations and any intermediate results are represented in the template may vary.

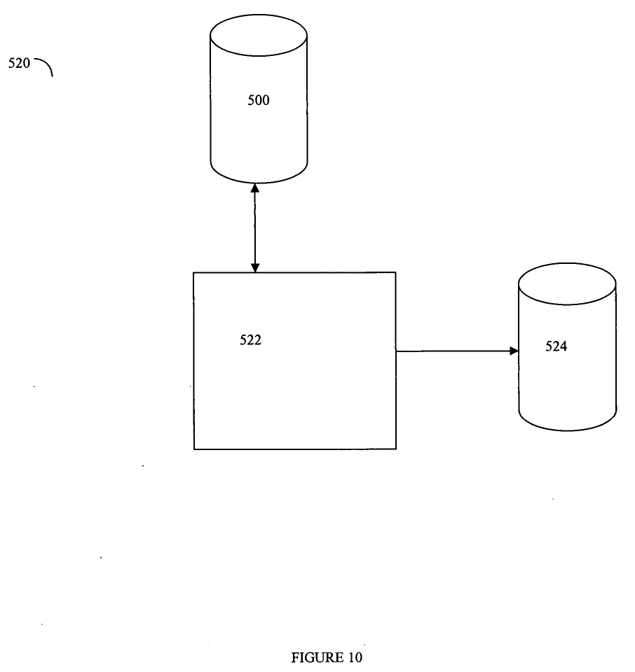

Referring now to FIG. 10, shown is an example of components that may be used in connection with generation of subject records and a template. FIG. 10 includes a template 500, one or more components 522, and one or more subject records 524. The element 522 may include components to perform generation of an initial template and subject record. The template may be created when generating an initial subject record, and recording steps for producing this initial subject record. The element 522 may also include components to perform generation of additional subject records using an existing template. The template may be used in connection with “replaying” the previously recorded steps. In one embodiment, code included in 522 may be executed which uses the data included in the template 500 to produce additional subject records.

As described elsewhere herein, the template such as 500 is associated with a particular subject. When a user wishes to create an instance of a subject record, such as subject record 524, processing steps as described elsewhere herein activate a component such as 522 which in this example may be a C# program and/or other tools used to read in the template file 500. In this example, the template file 500 is an XML file and the component 522 may conceptually correspond to one or more different customized or commercially available tools used to parse the XML file. The components of 522 may also generate as an output the subject record 524.

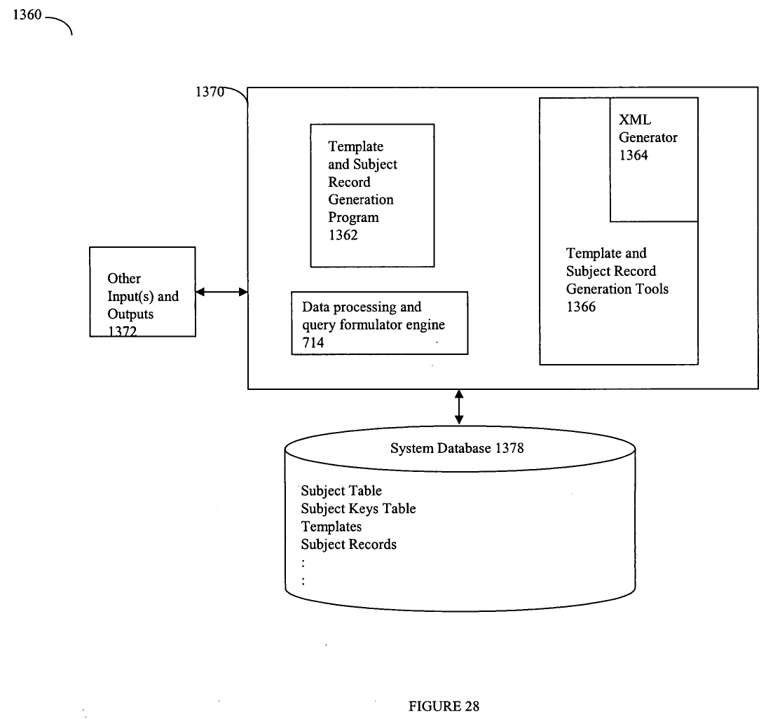

It should be noted that components of FIG. 10 are also described elsewhere herein in connection with other figures and other operations. For example, the processing performed by 522 represents a portion of the processing performed by elements of FIG. 28.

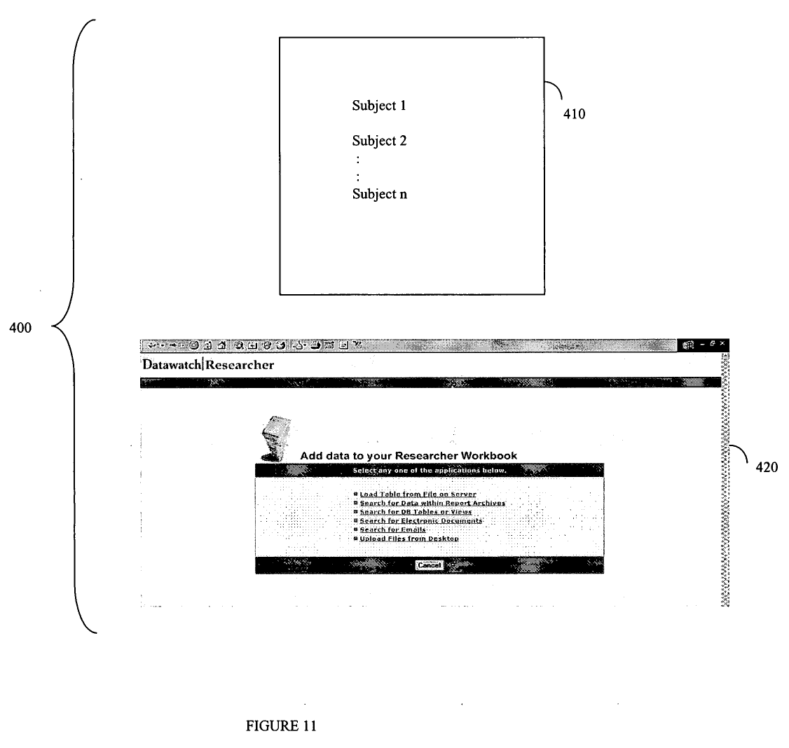

Referring now to FIG. 11, shown is an example 400 of screen shots that may be included in a dialogue for defining a template. Screen shot 410 may be displayed for a user to view one or more subjects. Each template created is associated with a subject in order to generate a subject record or instance of that particular subject. The user may select, for example, using an input device, one of the subjects displayed in screen shot 410. Subsequently, a list of data sources may be displayed as illustrated in connection with screen shot 420. A user may select a particular data source type as may be included, for example, in the display of screen shot 420. Upon selection of a data source type from screen shot 420, the user may then be presented with a screen including a list of one or more data files of that particular data source type.

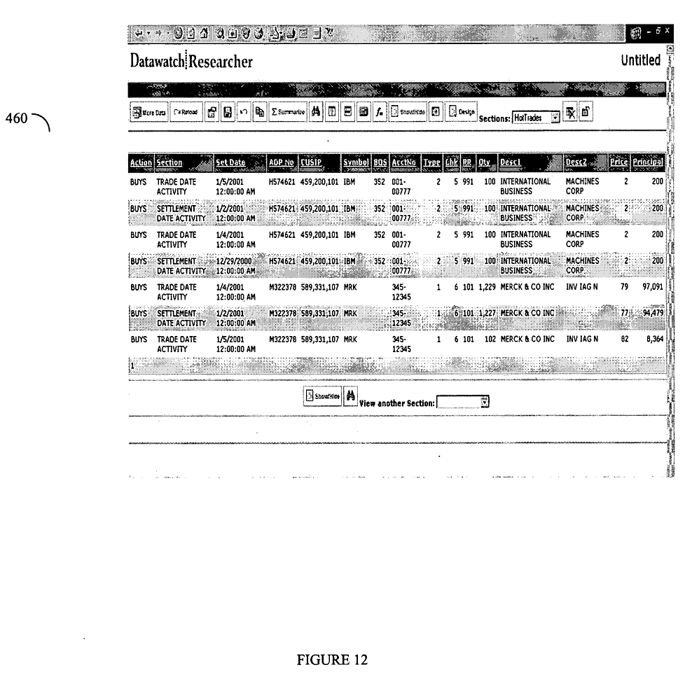

Referring now to FIG. 12, shown is an example 460 of a screen shot of how data may be displayed to a user in response to loading data from a particular data file. Subsequent steps may be taken by the user, for example, in connection with this screen shot 460 and others to select particular data fields, perform different types of analyses, and other processing steps using this single data source as well as other data sources. The steps performed by the user when operating upon one or more data files in this embodiment may be recorded. The information recorded may be used for repeatedly performing the same steps in order to produce one or more subject records at one or more subsequent points in time using different instances of data as may be included in each input data file at a particular point in time. In other words, the information that is recorded may be replayed to produce a subject record representing an instance of collected data at a particular point in time. As an example, a user may define a template for producing a report combining data from one or more different data files. The data included in a particular data file such as inventory may change at different points in time. It may be desirable, for example, to replay the same steps in generating a report weekly, monthly or at other time intervals. Using the techniques described herein, a user may create a template to define the processing steps necessary to generate a report. An embodiment of the server system may include scheduling software which generates reports at predefined time intervals or in response to the occurrence of defined events and/or conditions. For example, a user may define a time schedule providing for automatic generation of a report on a weekly or daily basis using the template. In the foregoing, the report may be characterized as a subject record whose instance of a subject corresponds to a report generated at a particular point in time. The report may be for a particular subject associated with a template and the one or more subject records.

An embodiment may include any one or more different types of operations in connection with the data that may be displayed and included from one or more data files. Operations that may be performed upon data files may include, for example, summarizing and defining totals, filtering data, defining new fields from derived data elements based on calculations, and the like. The particular processing steps may vary in accordance with each particular embodiment. Examples of the types of data processing operations that may be included in an embodiment are described in more detail in following paragraphs.

In connection with generating a template and creating a subject record, data may be aggregated from one or more possible disparate sources. The different types of possible sources that may be included in an embodiment are displayed, for example, in 420 of FIG. 11. Additionally, one or more data sources may be searched in an iterative fashion, and the search criteria for extracting data from a second source may be dependent upon output from a previously performed search. Generally, the techniques that will be described in connection with recording information for a template may include performing N searches where the nth search may use as search criteria results from any of the previous N-1 searches in addition to other criteria that may be available in a particular embodiment. A particular example will now be described.

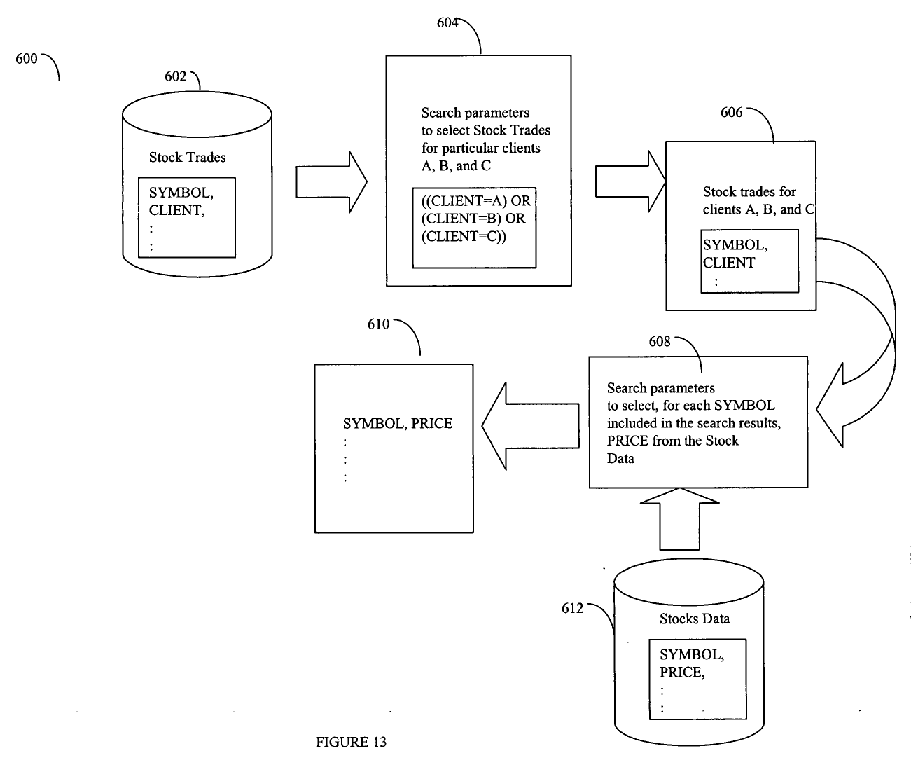

Referring now to FIG. 13, shown is an example 600 illustrating the data flow in connection with performing a correlated search using the techniques described herein. In this particular example, a first data source 602 may include data from a database regarding stock trades made over a particular time period. Each of the stock trade records may include information such as, for example, symbol and client data. The symbol may correspond to the particular stock symbol of the particular trade and the client may indicate a codename or other type of identifier of the particular client for which this particular stock trade was performed. Recorded in the template associated with a subject may be a first search query as represented by element 604. The user may enter and have recorded certain parameters to select those stock trades from data source 602 for particular clients A, B and C. As an output of this first search query, search results 606 may be produced which include those stock trades as included in database 602 for clients A, B and C. Element 606 may represent the search results for the first query represented by element 604. As part of the recorded template information, a second query may also be performed as illustrated and represented by element 608. Element 608 corresponds to the particular information stored in the template for providing such parameters and other information to select particular information from a second data source 612 based upon the particular stock symbols included in the data results 606 from the first query. For every symbol corresponding to a particular stock symbol in the first query results 606, a corresponding record within the second data source 612 is located and the price information is extracted. As an output of the second set of parameters of 608, the results 610 may be produced which include the symbol information and corresponding price of that particular stock as represented by the symbol.

As a result of performing processing in accordance with the dataflow process described with 600 FIG. 13, an embodiment may generate a subject record that may be used in producing a screen shot similar to that as illustrated in connection with FIG. 3. The particular screen shot representing the subject record produced by the data flow illustrated by 600 may include particular data fields, data sources, and the like, corresponding to those elements in connection with FIG. 13. It should be noted that an embodiment may provide for customization of what data may be displayed for a subject record created as a result of multiple queries. For example, an embodiment may allow a user to select options providing for suppression of the display of particular elements. With reference to FIG. 13, it may be that all that is displayed is the final result of element 610. Alternatively, an embodiment may provide options which display information about each of the data fields serving as input and data result output of each of the different queries. This may vary in accordance with each embodiment.

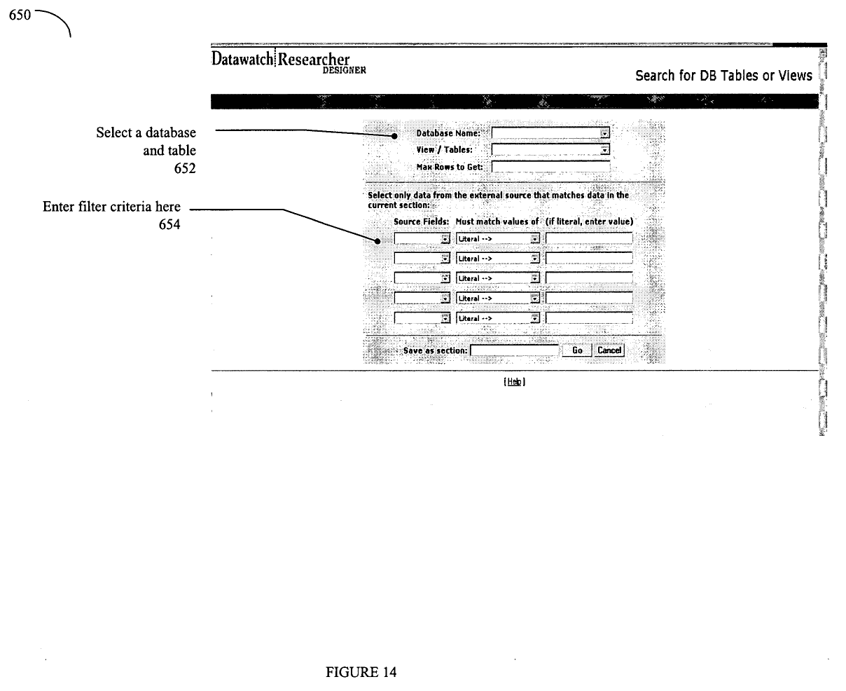

Referring now to FIG. 14, shown is an example of another screen shot 650 that may be displayed to a user in connection with selecting a particular data source used as input. Screen shot 650 may be displayed as a result, for example, of selecting the option “Search for DB Tables or Views” from screen shot 420 of FIG. 11. Screenshot 650 may be displayed as part of a dialogue in connection with specifying a data source 602 and associated search parameters and criteria specified in element 604. Information may be entered into field 652 to identify the data source, such as 602 of FIG. 13. Criteria may be entered in area 654 in order to properly filter out data records in accordance with the search criteria identifying clients A, B and C. Data included in field 654 may correspond to the data elements as illustrated, for example, in element 604 of FIG. 13.

It should be noted that the particular filter criteria may vary in accordance with each embodiment. The filter criteria entered, for example, in area 654 of FIG. 14 may be characterized as criteria used in analyzing the data. Other types of operations may be included in an embodiment to perform different types of analysis or data manipulation on one or more data sources. For example, an embodiment may include functionality which allows for grouping or arranging input data in accordance with a report format, creating additional columns of data elements displayed representing calculations or other intermediate values, suppressing particular columns of data from a displayed table, using the values of particular columns to define an ordering of elements in a table of the subject record, exporting data such as the search results from one of the queries to one or more other formats producing intermediate output files, and the like. Other operations that may be performed include bringing in data from a second source to be combined with all or a portion of a first set of data in which these two data sources may for example have a common key. For example, a first data file may contain a first set of information on a person. A second data file may include different information about the same person. Data from both first and second data files may be joined into a table represented in the subject record (e.g., element 108 of FIG. 3). Analysis of a particular query may then be performed on this joined result.

Additionally, an embodiment may include a dialogue allowing a user to specify searching criteria which is dependent on previous search results. For example, data from a first query result may be used as criteria for searching a second data source which produces second search results. This is illustrated in more detail in the following example.

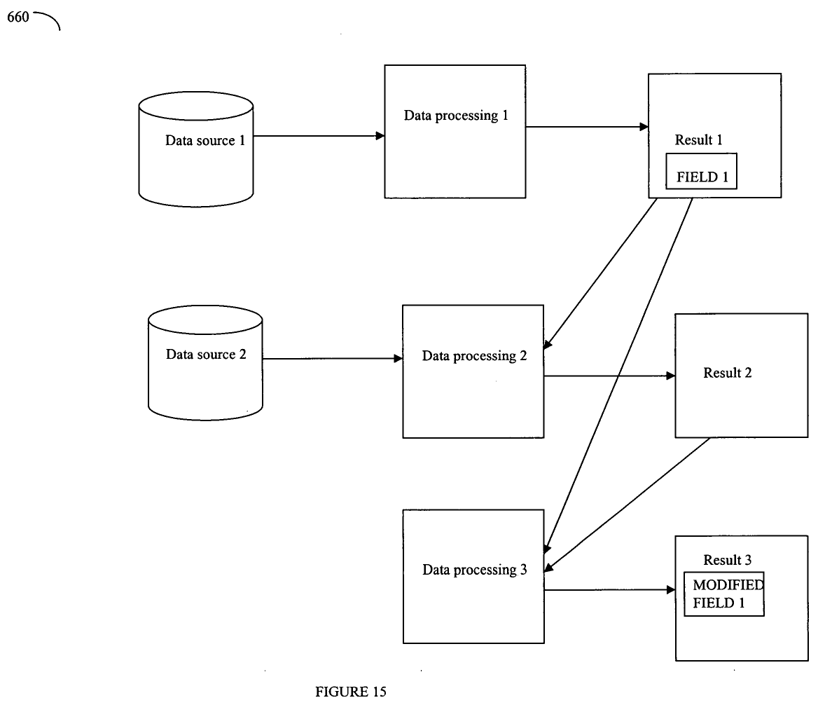

Referring now to FIG. 15 shown is an example of data flow in another embodiment illustrating the correlated searching techniques herein. In this example 60, three different sets of data processing operations including particular criteria (e.g., such as search query parameters) may be represented as data processing 1, data processing 2 and data processing 3 illustrated in FIG. 15. It should be noted that each of the data processing elements may include criteria such as searching criteria, filtering criteria or other manipulation and processing to be performed on a data source such as data source 1. In connection with performing the data processing, it should be noted that an embodiment may use an application or other software in accordance with the particular data source. As an example, a data source may be a data file stored in a document management system. In order to read the document from the document management system, the document management system software may be activated in connection with data processing in order to read a data source as input in accordance with the specified data processing criteria. As another example, data processing criteria may be specified as query parameters serving as input to a search engine such as Google. The data source may be one or more documents or other files that may be used in a format in accordance with a particular search engine. The results produced may correspond to the search results after invoking the particular search engine in accordance with the query terms specified. In order to operate on the particular input source used by the search engine, search engine software may be activated, passed the particular search query, and provide output results corresponding, for example, to result 1.

What will now be described are processes and components that may be used in connection with an embodiment performing correlated searching through data sources. Such correlated searching may be part of the process for generating a subject record and may be recorded in connection with a template. The techniques described herein may be used to aggregate data from multiple data sources of varying types, and in producing one or more queries with results including a single final data set as well as one or more search results for intermediate queries.

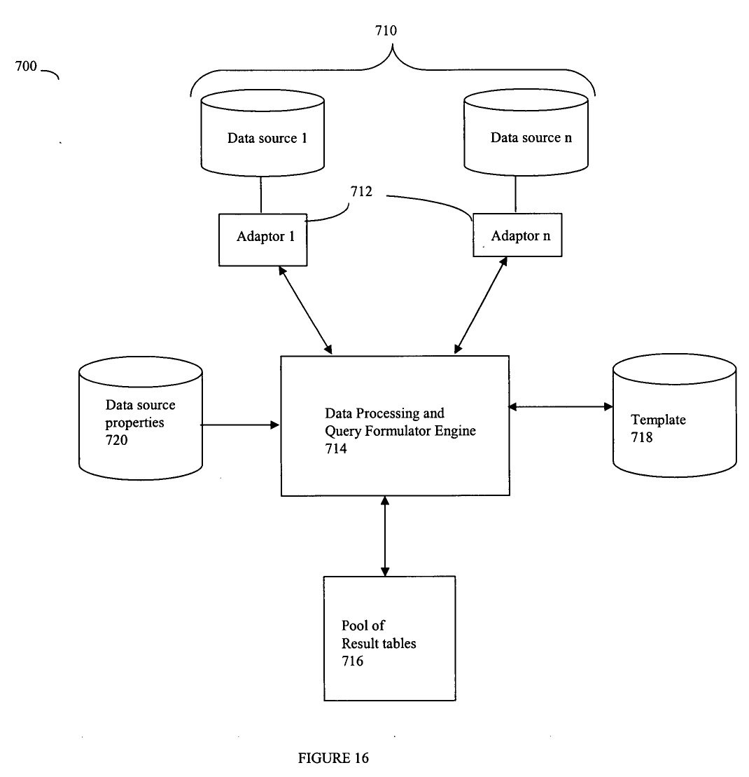

Referring now to FIG. 16, shown is an example 700 of components that may be included in an embodiment performing the techniques described herein in connection with correlation of data from one or more data sources. The components of FIG. 16 may be included in the server system 12 of FIG. 1 and used in connection with performing a portion of the processing steps associated with subject record generation and template creation. Included in the example 700 is a data processing and query formulator engine 714 which takes, as input, data from one or more data sources 710. The data processing and query formula engine 714 interfaces with one or more adaptors 712. Each of the adaptors may be customized and specialized for interfacing between a particular data source, any software (e.g., a database application) for accessing the data source, and the engine 714. As an example, if data source 1 is data included in a database, the adaptor 1 may perform processing steps in connection with issuing one or more commands to a database application in order to access the data within the data source 1. If the data source 1 is in an SQL database, its corresponding adaptor 1 may formulate one or more SQL commands from a query communicated by the engine 714. The adaptor 1 may issue the one or more SQL commands the appropriate database application in order to access the data from the data source. The results of the query are returned to the adaptor from the appropriate database application. The adaptor then takes any steps to place the data in a format to be returned to the engine 714. Each of the adaptors may be characterized as an interfacing layer which facilitates communication with a particular data source in transmitting information between a data source and the data processing and query formulator engine 714. Thus, each of the adaptors may perform any one of a variety of different operations in connection with operating from a data source in connection with particular commands, such as query parameters, communicated from the data processing and query formulator engine 714.

Other inputs to the data processing and query formulator engine 714 may include a template 718 and data source properties 720. One embodiment of the template 718 is described elsewhere herein as a template as may be associated with a particular subject and subject record. It should be noted that in connection with producing an initial subject record, the template 718 may be produced as an output of 714. At a later point in time, the same template 718 may be used an input to 714 to create additional subject records in an automated fashion by executing code included in 714 to replay the recorded information in the template 718.

As another input in this embodiment to the data processing and query formulator engine 714, the data source properties 720 may be used to determine the particular properties in connection with accessing a particular data source through an adaptor. In one embodiment, the template 718 may include information identifying a particular data source. A particular data source may be, for example, a .DOC file corresponding to a document used in connection with a word processing application. In this instance, a data source may be identified by a file name or type of file such as the .DOC extension. When the engine 714 attempts to access the data source, the engine 714 may consult an entry in the data source properties file 720 which specifies information used in connection with accessing data contained in a .DOC file. The data source properties file 720 may include an identifier for the particular adaptor to use, a connection string or path as to where the particular adaptor may be located, and additional information regarding the type of data source. It should be noted that other information may also be included in the data source properties file 720 and may vary in accordance with the particular data source.

The pool of result tables 716 represents the one or more results produced by the one or more data processing and/or query steps that may be performed by the engine 714. Results included in the pool of result tables 716 may also serve as an input to the component 714. This is described in more detail elsewhere herein. It should be noted that although FIG. 16 does not illustrate an adaptor for use with results of 716 that may be produced by the engine 714, an embodiment may include functionality such that the query formulator engine 714 stores results 716 in a form used with an adaptor. An embodiment may also store the results of 716 in an internal format or temporary storage location used by the engine 714 possibly in subsequent durations without use of an adaptor.

It should be noted that, although not explicitly included in FIG. 16, the engine 714 and other components of FIG. 16 may utilize third party software in connection with performing processing that may vary in an embodiment. For example, the engine 714 may utilize a third party parser in order to process the template 718. In one embodiment, the template 718 may be an XML file and the engine 714 may utilize a third party XML parser in connection with reading in the template 718.

It should be noted that the engine 714 of FIG. 16 may be invoked in connection with a program, such as a browser, or operating system. The template 718, or an identifier of the template 718, may be passed as an input parameter to the engine 714 upon invocation. The engine 714 may also be invoked, for example, in connection with scheduled processing used to generate one or more subject records based on a particular template upon the occurrence of particular events or predetermined times. As an example, a scheduler may invoke the engine 714 to produce a subject record at predetermined time periods. The scheduler may invoke the engine 714 passing it the particular template 718 or a pointer thereto. Once invoked, the query formulator engine may execute the data processing operations specified by the template by connecting to the specified input sources and producing the pool of result tables 716. In one embodiment, the pool of result tables 716 may be an XML stream. After completion of processing by the engine 714, the engine 714 may pass the XML stream representing the pool of result tables 716 to a program or an XSL template to be converted into a result for subsequent viewing, for example, by a browser or other application. The XML stream may also be passed to one or more other applications for further processing.

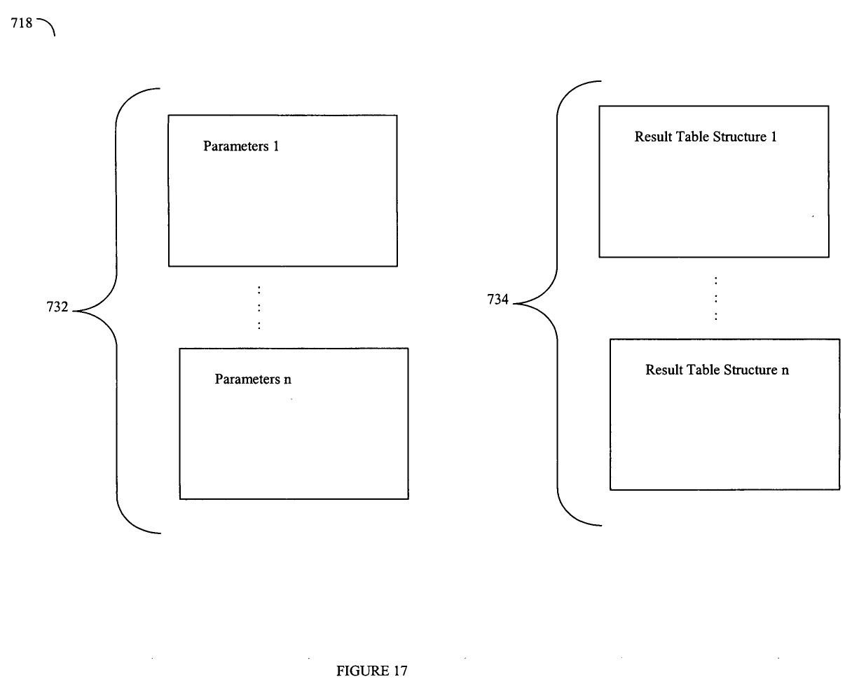

Referring now to FIG. 17, shown is an example representation of data elements that may be included in a template file in accordance with the particular data sources and associated filtering or querying operations. It should be noted that the elements represented in 718 may correspond to only a portion of the data included in a complete template file. As described in more detail elsewhere herein, for example with reference to FIG. 9, the template file may include data corresponding to other data processing operations besides those used in connection with the data sources and correlated searching. For example, the template file may also include hyperlink definitions, intermediate calculations and other derived values, and the like.

The representation 718 may include one or more sets of parameters 732 and one or more sets of result table structures 734. In one embodiment as described elsewhere herein, the template file may be an XML file defining parameters used in connection with a processing step performed by the engine 714. Each of the parameter sets of 732 (e.g., parameter n”) has a corresponding result table structure in 734 (e.g., result table structure “n”) providing a description of the results of a particular processing iteration by the engine 714 when using the associated parameter set.

In one embodiment, the parameters and corresponding result table structure may correspond to a query or other processing step that may be performed by the engine 714. The input parameters included in an instance or parameter set of 732, such as parameters 1, may include the following information: the identifier of the data source to be accessed having additional details which may be maintained in the source properties component 720, the name of the table or other structure within the particular data source to be accessed, additional information that may vary with the particular type of data sources (e.g., unstructured data may use a particular data range), an optional correlating expression referencing results from one or more previous queries or data operations and associated operators, an identifier to the particular location referenced in previous results of 716, and the like.

The result table structures of 734 describe the resulting data elements produced by the engine 714 using the corresponding set of parameters of 732. For example, the template may describe a data source as a particular type of database for which the engine 714 is to perform a query using the parameters denoted as “parameters 1”. A portion of the query results (e.g., particular fields of each resulting record) are extracted and have a structure or format specified in the “result table structure 1”. Results returned from the database are placed in a form as specified in the result table structure by the appropriate adaptor prior to being returned to the engine 714. Thus, an adaptor maps the parameter set “parameters 1” into one or more statements with associated formats in order to properly interface with the database. Results returned from the database, or portions thereof, are then accordingly mapped into a result structure in accordance with result table structure 1. This mapping process may include, for example, only returning particular fields that may be included in results returned by the database as well as changing a particular format and location in accordance with a result table structure 1. The adaptor then passes this information back to the engine 714.

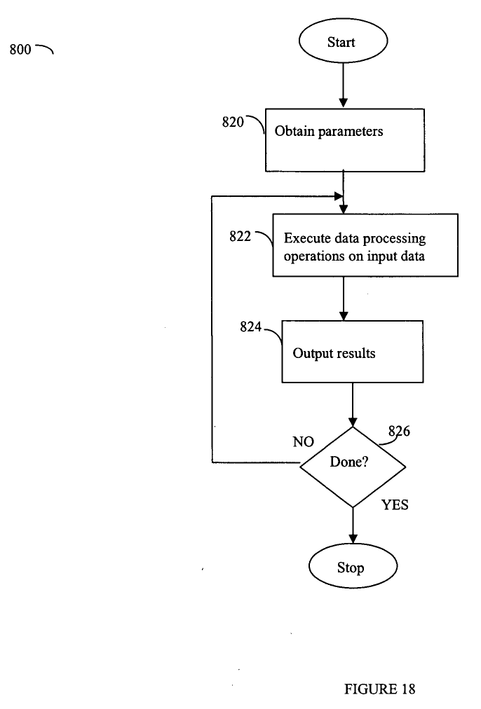

Referring now to FIG. 18, shown is a flowchart 800 of processing steps that may be performed in one embodiment by the engine 714. The processing steps of 800 summarize the processing described in connection with FIG. 16. Note that the flowchart 800 specifies processing steps for generating a subject record using an already existing template. The processing steps are similar in creation of the first subject record. When using the template, processing inputs correspond to recorded user selections and actions using the template rather than from interactive user selections when creating the initial subject record and the template. At step 820, parameters are obtained, for example, from the template 718. Control proceeds to step 822 where data processing operations are performed on one or more input data sources. The processing of step 822 may include, for example, performing a query using input parameters and input data specified in the template. Control proceeds to step 824 to output results, such as query results in accordance with the current data processing operation. The form of the results may be specified, for example, in the result table structure included in the template. At step 826 a determination is made as to whether processing is complete. If so, processing stops. It should noted that the result tables may be used in connection with generation of the subject record in any one or more different forms that may vary which each embodiment. Otherwise, if step 826 determines that processing is not complete, control proceeds to step 822 to perform processing in accordance with the next set of parameters.

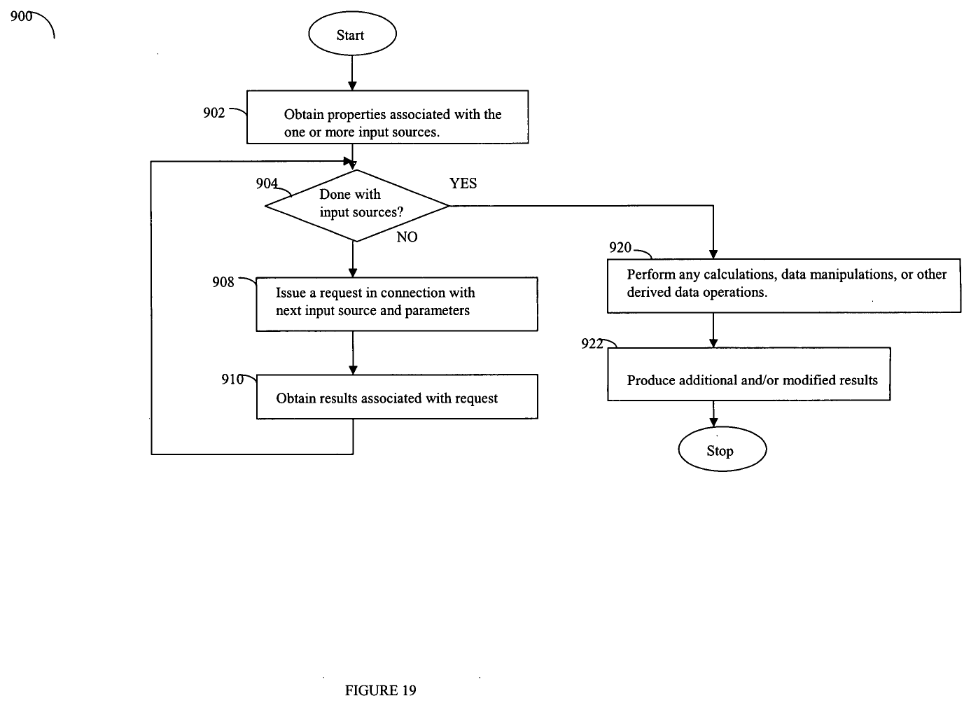

Referring now to FIG. 19, shown is a flowchart of more detailed processing steps that may be performed by the engine 714 in connection with performing a single data processing iteration, such as in connection with step 822. At step 902, the properties associated with one or more input sources are obtained. These properties may be obtained, for example, from the data source properties file 720 as described elsewhere herein. The properties may be used in connection with accessing a particular adaptor and operating on a particular data source. At step 704, a determination is made as to whether processing is complete for the input source(s) associated with the current iteration. It should be noted that a single iteration as described, for example, in connection with FIG. 18 and FIG. 19 refer to processing associated with a single set of parameters on one or more data sources. For example, this may include, referring back to FIG. 15, step “data processing 3” which operates on “result 1” and “result 2”, or “data processing 2” which operates on “data source 2” as well as a prior “result 1”. If a determination is made at step 904 that processing is not complete for all of the input sources for the current iteration, control proceeds to step 908 to issue a request in connection with the next input source and associated parameters. At step 908, the request may be issued, for example, from the engine 714 to the appropriate adaptor. At step 910 the adaptor returns results associated with a particular request. Control then proceeds to step 904 with the next input source. It should be noted that steps 904, 908 and 910 may be performed multiple times for a same input source, as well as for different input sources. For example, multiple requests may be issued in connection with accessing a database. Multiple requests may be used to perform various operations needed in accordance with the particular database. Additionally, a single iteration of 714 may include accessing a first portion of data from a first source, and a second portion of data from a second different source, and presenting the results in a single table displayed in a subject record. If a determination is made at step 904 that processing is complete for the input sources, control proceeds to step 920 to perform any calculations, data manipulations or other derived data operations as may be performed on the one or more results returned from the one or more adaptors. At step 922, any additional or modified results are produced and generated as may be stored for example in the result pool 716.

As an example illustrating the difference in results that may be produced, for example, by steps 910 and steps 922, an input source may be a database and a query may be made in connection with that database in accordance with the particular parameters. Results may be returned by the adaptor in connection with step 910 processing. The template may specify that data manipulations or calculations may be performed in connection with the results returned from the database query. For example, a name field may be returned as the result of a database query. This particular name may be reformatted or otherwise manipulated, for example, by swapping first and last name ordering to produce modified results. Additionally, calculations may be performed, for example, adding or otherwise performing mathematical operations on the numeric data values returned from the database in step 910. This may also produce additional results at step 922.

Referring back to FIG. 17, one of the parameters included in, for example, “parameters n” of 732 may refer to a data element from a prior result, such as a field described in “result table structure 1”. Data of the previous results corresponding to “result table structure 1” may be stored, for example, in a form requiring use of an adaptor. Thus, in connection with accessing prior results from previous queries or other data processing steps, the template may include other information in order to access the necessary previous results.

It should be noted that adaptors 712 may be characterized as processes whose logic and design may be coded specifically for each of the particular data sources. The particular data sources and associated adaptors may vary with each embodiment in order to interface appropriately with the one or more data sources supported in an embodiment. In one embodiment it should be noted that components such as the template 718 and the pool of results table 716 may be stored in an XML format. However, as will be appreciated by one of ordinary skill in the art any one of a variety of different alternative formats may be used. For example, a set of SQL database tables may be used in connection with the template 718 and/or the pool of results table 716. In another embodiment, one or more of the components such as 716 and 718 may have their corresponding data stored in a text file or other data container and associated type as may vary with each embodiment.

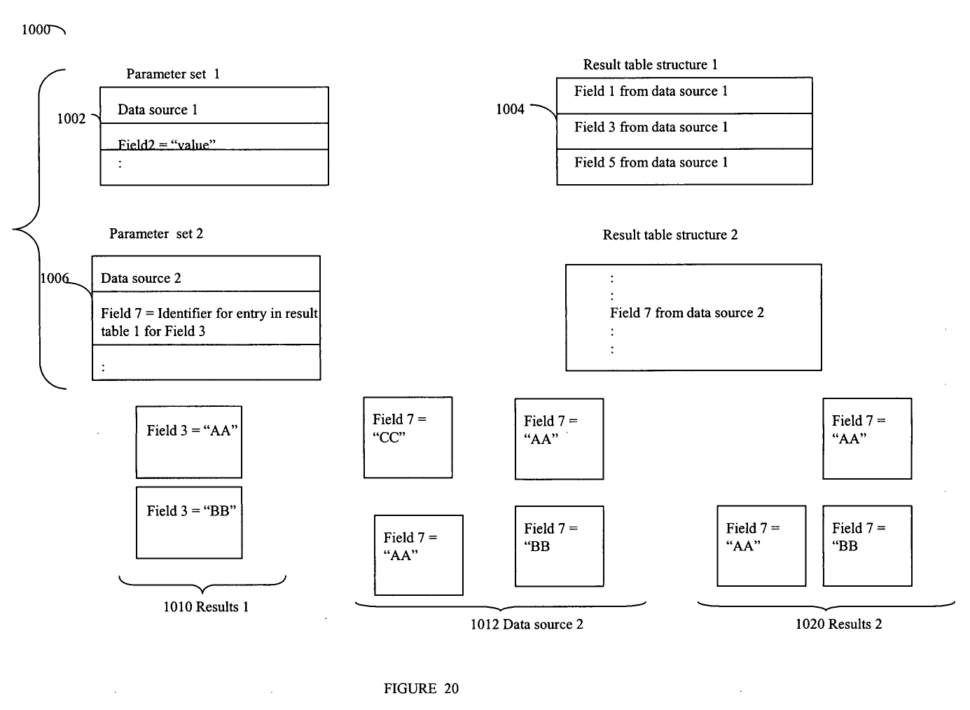

Referring now to FIG. 20, shown is an example 1000 of a representation providing more detail regarding an instance of a template, such as a template 718. A first parameter set 1002 may include data elements specifying data source 1 and relevant data elements and expressions associated with a query. In parameter set 1 1002, the expression “field 2=value” may represent the expression of field 2 having a “value”, where value can be a literal, numeric quantity, or other complex expression. The expression “field 2=value” may be a query parameter used in connection with performing a query on data source 1. In this example, a query is performed such that records are extracted from data source 1 for all instances of field 2 equal to the specified “value”. For each of these records, data from fields 1, 3, and 5 is extracted and expected in a format as defined in result table 1 1004. The extracted data represents the first set of results. In connection with a second iteration of data processing, which in this example may be a second query, a second parameter set specified by 1006 is illustrated. In this example, 1006 specifies that the data source is data source 2. Additionally, a query parameter is specified in the second value for all records within data source 2 having “field 7” equal to a particular value. In this example, the particular value that field 7 must be equal to is dependent upon field 3 as included in the previous first search results.

To further illustrate data that may be returned in connection with the different data sources and results, a simple illustration will now be made with reference to a particular data set. In this example, element 1010 may represent two records included in a first result set produced from a first query in accordance with parameter set 1002. The data elements included in the two records for 1010 are stored in accordance with the format specified in result table structure 1004. Subsequently, a second query is performed using a second parameter set 1006. Data source 2 in this example includes four records as illustrated in element 1012. In accordance with the query parameters of parameter set 2 1006, data source 2 1012 is queried. Each of the values of field 7 for all records included in 1012 are examined to determine whether the field 7 of each of those records is equal to a particular instance of field 3, as included in 1010. In other words, a comparison is made between the value of field 7 for each record to see whether an instance of field 7 as included in 1012 is equal to “AA” or “BB”. As a result of performing this query, a second result set may be produced as specified in element 1020. In this example, three of the four records of the data source 2 include field 7 values in accordance with the specified parameter set 1006.

It should be noted that the complexity of a particular expression as may be used in connection with a parameter may vary in accordance with each embodiment. In one embodiment, a parameter set may include a description corresponding to a query parameter based on a comparison to a literal string, an integer value, as well as a more complex string or numeric expression, such as one including one or more operands and operators. The precise manner and how the representation of each of the different elements included in 1000 may be represented and stored in a template may vary with each embodiment. Similarly, the way in which calculations and other elements included in the template are specified may vary with each embodiment. In one embodiment, the query parameters may correspond to expressions including, for example, compound logical or mathematical statements as well as single operands.

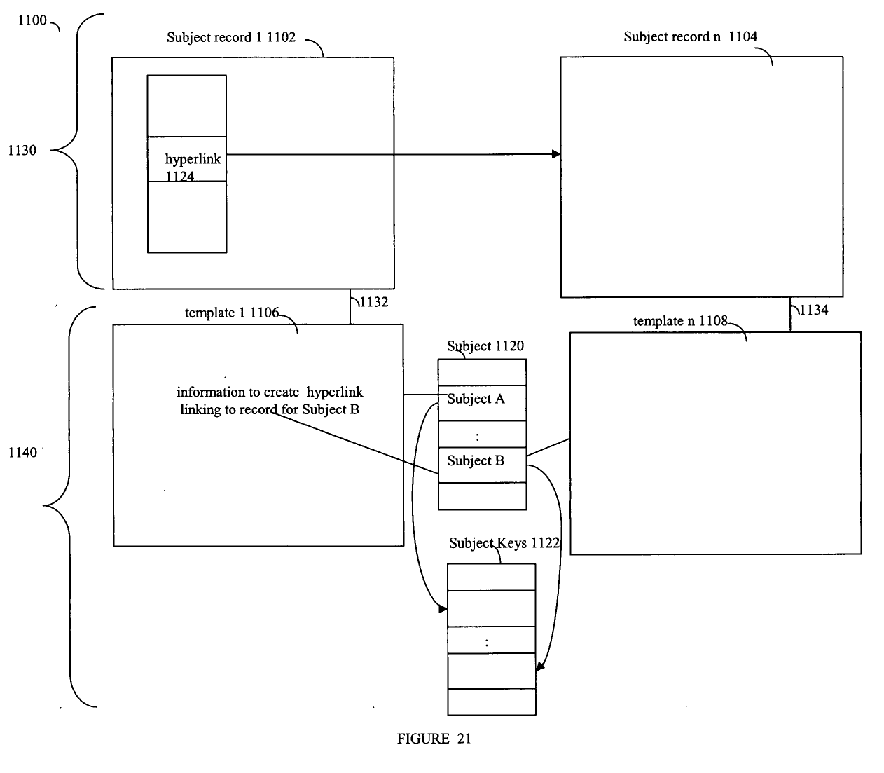

Referring now to FIG. 21, shown is an example illustrating how subject records of related subjects may be referenced using a hyperlink. As described elsewhere herein in more detail, selection of the hyperlink in a displayed page causes invocation of a subject search engine to facilitate the linking of related subject records. Additionally, shown in the example 1100 are the relationships between the subject records and associated templates and tables as may be included in an embodiment. The example 1100 includes a top portion 1130 and a bottom portion 1140. The top portion 1130 includes subject record 1102 and subject record 1104. As described elsewhere herein, subject records may be characterized as instances of particular subjects at a point in time. A template may be used in connection with creation of each of the subject records 1102 and 1104. The bottom portion of FIG. 21 1140 includes other components associated with the subject records in portion 1130. Subject record 1102 and subject record 1104 may be viewed using a browser. Each of the subject records 1102 and 1104 may be coded in HTML for display and viewing with a web browser. Subject record 1102 may include a hyperlink 1124 associated with one of the fields included in subject record 1102 when displayed. Upon selection of hyperlink 1124, subject record 1104 may be subsequently be displayed in the browser. The hyperlink 1124 may be used to establish a link between records of related subjects as will be described in more detail in following paragraphs.

Each of subject records 1102 and 1104 is associated with a subject included in the subject table 1120. Portion 1140 includes subject table 1120, subject keys table 1122, and templates 1106 and 1108. When template 1106 is initially created, the template 1106 may be associated with a selected subject from table 1120. In this example, template 1106 is associated with subject A. This, and other associations, may be facilitated by a user interface as part of a dialogue in connection with creating the template 1106.

Each of the subjects of 1120 may be associated with one or more subject keys of table 1122. The table subject keys 1122 may include attributes identifying a particular instance of a subject. For example, if a subject included in table 1120 describes an “account”, such as a bank account, brokerage account, and the like, a corresponding subject key of table 1122 may be associated with the subject “account” to identify a particular instance of that subject. One of the subject keys that may be used to identify an “account” is an account number. If subject A is the account, the corresponding subject key which is the account number may be included in table 1122. The relationship between subject A of table 1120 and its subject key in table 1122 may be represented by the arrow from subject A to one of the entries in the subject key table 1122. As another example, a subject may be “employee”. The employee may be identified by two subject keys of “last name” and “first name”. In this example, “first name” and “last name” may each have a row or entry within the subject keys table 1122.

A template such as 1106 may be initially created by recording processing during generation of a first subject record. At a later point, the template may also be used in connection with creating one or more additional subject records corresponding to instances of the subjects related to the particular template. As part of the process of initially creating the template 1106, the template 1106 may be associated with a subject, such as subject A. This association is represented by the connector between subject A of table 1120 and the template 1106 in FIG. 21. Each of the one or more subject records may also be associated with a template. In FIG. 21, the association of a subject record and a template is illustrated by the connector 1132. As part of the process of creation of the template 1106, information may be included within the template 1106 to provide for creation of the hyperlink 1124 when a particular subject record is created. In this example, as part of the template creation process for template 1106, information may be stored in the template. This information may be used when generating a subject record including 1124, for example, which links a current subject record for a first subject to a second subject record of a related second subject. In this example, a user creating the template 1106 may indicate that subject A is related to subject B. In the portion 1140, subject B is associated with template 1108. Template 1108 is associated with subject record 1104 as represented by connection 1134. Similarly, subject B included in the subject's table 1120 is associated with an entry in the subject keys table 1122.

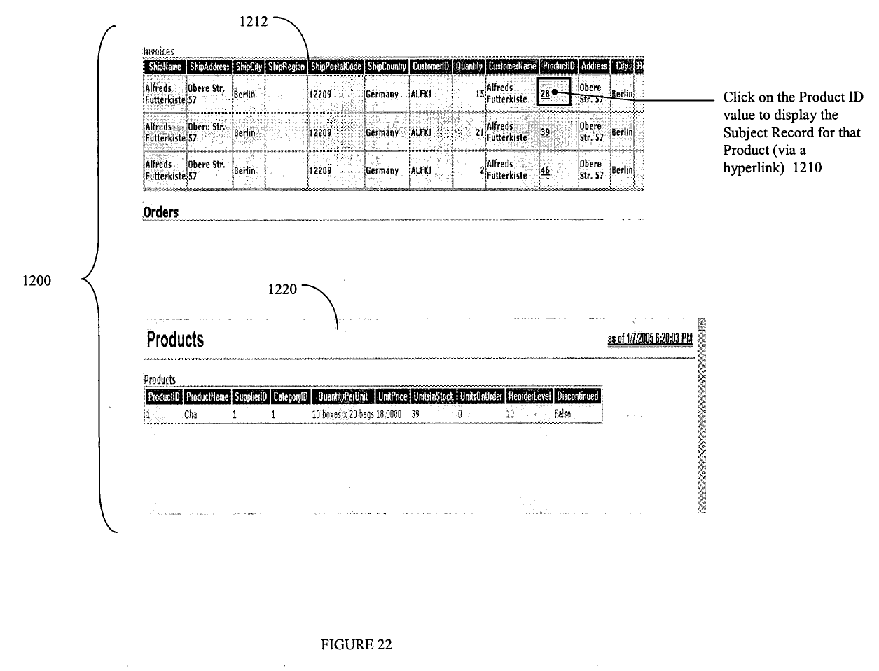

Referring now to FIG. 22, shown is another example 1200 of screen shots illustrating subject records and associated hyperlinks in more detail. Screen shot 1212 may be displayed and may correspond to a particular subject record such as subject record 1102. Upon selection of a particular field such as 1210 corresponding to a hyperlink in the subject record 1212, the current screen shot represented by 1212 may be replaced by the screen shot 1220. In this example, selection of hyperlink 1210 results in displaying another subject record corresponding to a product ID for a particular product. Thus, FIG. 22 illustrates how a first subject record 1212 may be linked to a related subject record 1220 through a hyperlink 1210 which, when selected, causes invocation of a subject search engine. As a result of selection of the hyperlink 1210, the related subject record 1220 may be displayed. Example 1200 is a more detailed illustration of portion 1130 of FIG. 21 with subject records 1102 and 1104.

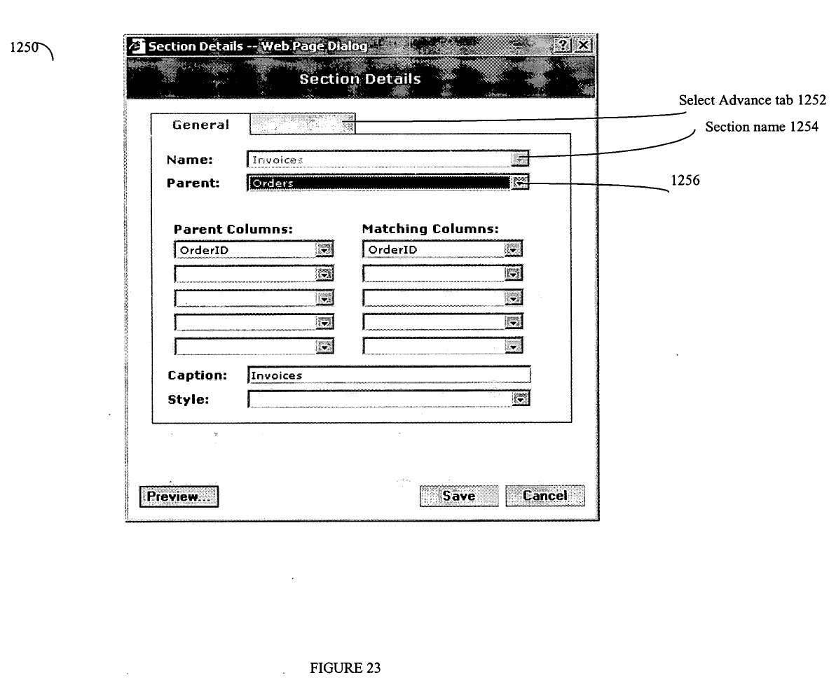

What will now be described are screen shots of FIGS. 23 through 27 as may be included in an embodiment as part of the template creation process. In particular, screen shots that may be included as part of the dialog for defining a hyperlink which, when selected, invokes the subject search engine are now described. The template may include data recorded during the hyperlink definition process. The recorded data may be used in generating a subject record which, when displayed via a browser in one embodiment, may result in generation of the hyperlink invoking the subject search engine when selected.

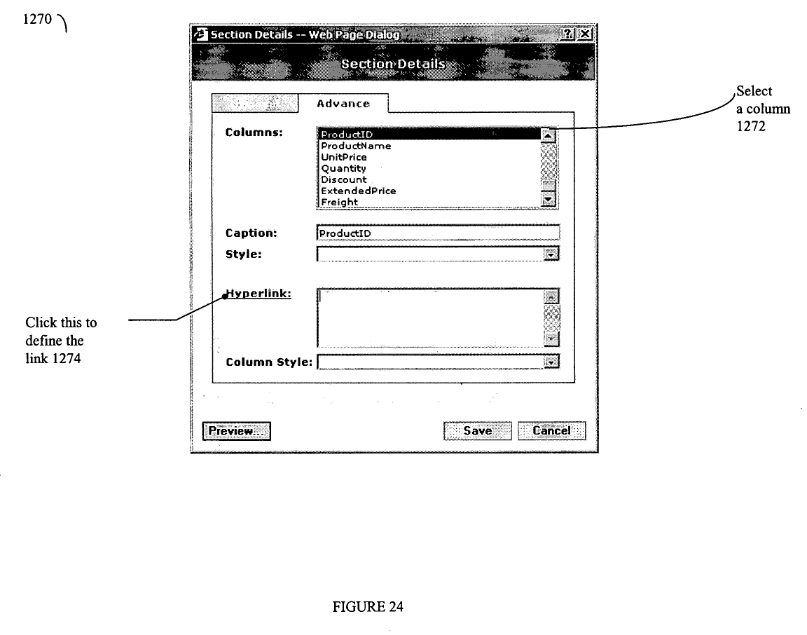

Referring now to FIG. 23, shown is a screen shot 1250 that may be displayed as part of the dialogue for creating a hyperlink used in connection with the subject search engine for linking to related subject records. Screen shot 1250 and others described in the following paragraphs may be included in an embodiment as part of a dialogue for use in connection with creation of the hyperlink 1210 of the previous subject record 1212. In one embodiment, the subject record may be divided into one or more portions or sections. Each section may correspond, for example, to an iteration of the engine 714 described elsewhere herein using a set of parameters and producing results. In this example, each of the portions or sections may be named as specified in 1254. Once screen shot 1250 is displayed, the advance tab 1252 may then be selected resulting in the display of screen shot 1270 of FIG. 24.

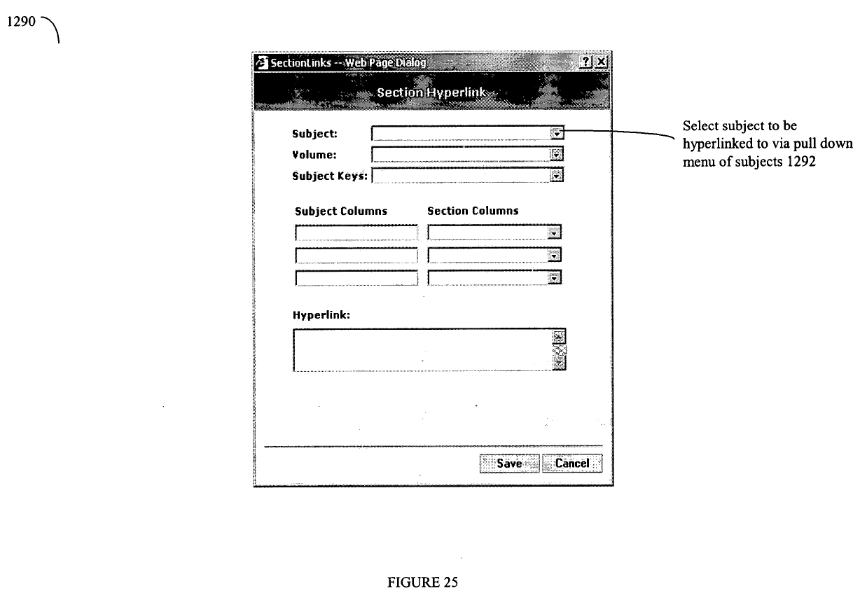

Referring now to FIG. 24, the screen shot 1270 may include a portion 1272 to select a column in a data section or table of the subject record for the hyperlink. In this example, product ID is selected as a field of the subject record. Subsequently, the hyperlink option 1274 is selected from the screen shot 1270 to continue a dialogue for obtaining information used to define the hyperlink. Selection of field 1274 results in display of screen shot 1290 of FIG. 25.

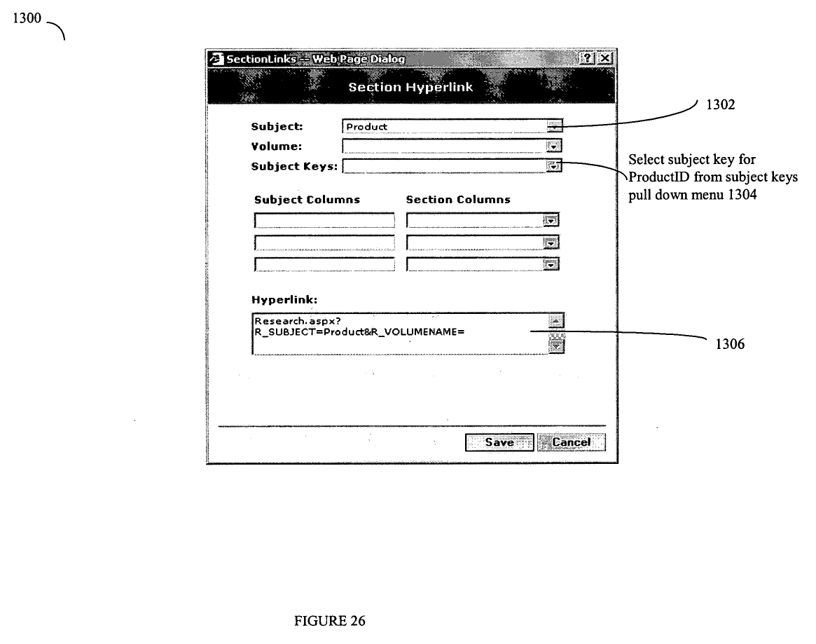

Referring now to FIG. 25, shown is a screen shot 1290 that may be used in connection with further defining the hyperlink to be included in a subject record. Included in screen shot 1290 is a subject field. By selecting element 1292 from screen shot 1290, a pull-down list may be displayed including a list of those subjects defined in an embodiment. This list of subjects displayed in the pull-down menu associated with 1292 may include those subjects defined within the subject table 1120 as previously described in connection with FIG. 21. From the pull-down list displayed by 1292, a user may select “product” resulting in the display of screen shot 1300 of FIG. 26.

Referring now to FIG. 26, shown is a resulting screen shot 1300. After selection of a particular subject, such as “product” included in 1302, the user may continue to enter other information in connection with the creation of the hyperlink dialogue. For example, the user may select the element illustrated by 1304 resulting in display of a pull-down menu of subject keys. It should be noted that the pull-down list displayed as a result of selection of 1304 includes those subject keys defined for the particular subject selected and identified by field 1302. The one or more subject keys that may be displayed may be those one or more subject keys included in subject key table 1122 which are associated with a particular subject of the subject table 1120. Screen shot 1300 may represent the display after selecting. “product” as a particular subject in 1302 and prior to selecting a subject key via the menu of 1304. Example 1300 includes a field 1306 which is also updated as a result of selecting the subject “product” of 1302. The information included in field 1306 is data included in a template and resulting subject record to define a hyperlink and invoke the subject search engine. The data of field 1306 used to define the hyperlink is added to in following screen shots. The information included in the final result of the hyperlink field 1306 of following figures may be included in a template. When the template is used to create a subject record, the information from 1306 may also be included in the generated subject record and used in connection with defining a subject search link to link together related subject records. Thus, field 1306 of 1300 represents a particular point in time in this dialogue after the “product” has been selected as the subject in field 1302, but prior to selection of a particular subject key for 1304.

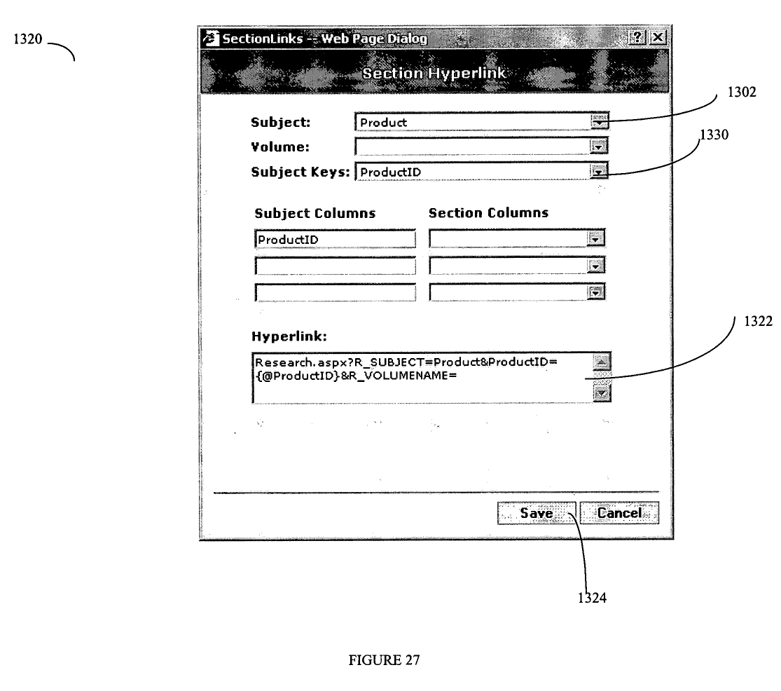

Upon selection of product ID from a pull-down menu 1304, screenshot 1320 of FIG. 27 may then be displayed. As a result, the subject keys field 1330 includes the product ID to reflect the selection of 1304. Additionally, the hyperlink section 1322 has been updated to include the selected subject key product ID information. At this point, the user may select the save option as indicated by button 1324 to close the section hyperlink dialogue. The information of 1322 is:

Research.aspx?R_SUBJECT=Product&ProductID={@ProductID}&R_VOLUMENAME

and may be used in defining the hyperlink as follows:

where

Research.aspx may be included in a URL identifying a page invoking the subject search engine; and

subject=“Product” and the current value of the key=ProductID” are passed as parameters to the page.

Note that “@ProductID” references the current value of the ProductID that is selected (e.g., clicked on) at the time the page is displayed. The above parameters passed to the page may also be passed as parameters to the invoked subject search engine described elsewhere herein. The subject search engine may perform processing to facilitate the selection and linking to a related subject record in accordance with the subject search engine parameters.

Referring now FIG. 28, shown is an example 1360 of components that may be included in an embodiment utilizing the techniques described herein for template and subject record generation. Element 1370 may include template and subject record generation program 1362, template and subject record generation tools 1366, and the data processing and query formulator engine 714. Prior to generating any templates or subject records, the system database 1378 may be initialized to include a populated subject table and subject keys table with appropriate associations made between subjects and subject keys. Subsequently, components 1362, 714, and 1366 may be executed in connection with creating a template as a user walks through the steps for creating an initial subject record associated with the template. During creation of the initial subject record, the user's interactions may be recorded. These interactions may include, for example, interactions with the system database 1378, one or more input sources of 1372 and any data processing performed in connection therewith. The creation of a template and the information that may be recorded therein is described elsewhere herein in more detail. After the initial subject record and the template have been created, the initial subject record is appropriately associated with the template and registered within the system database 1378.

The element 1372 may include, for example, the data sources and adapters, data source properties file and query results as described in connection with performing correlated searching. Such components are referenced, for example, in FIG. 16. The system database 1278 may include elements such as, for example, the subject table, subject keys table, templates and subject records as described elsewhere herein. The subject table and subject keys table may be used in connection with creating an initial template and registering a subject record in the database. Additional details regarding the elements of FIG. 28 and their use in connection with different processing steps are described elsewhere herein.

In one embodiment, the engine 714 and the template and subject record generation program 1362 may be written in a commercially available programming language such as C#. The components 1362 and/or 714 may interact with other third party commercially available software to assist in the generation of the template and subject record. In this embodiment, the component 1362 may interact with the component 1366 may be, for example, the Microsoft .NET framework. The template files and subject records as may be stored within the system database 1378 may be stored in XML format. The components 1366 may include a code generator, such as an XML generator 1364, used by the component 1362 in generating the template and subject record in the required XML form. It should be noted that an embodiment may use other components than as described herein in connection with generation of the template and subject record and may store the information in one or more different forms. Additionally, it should be noted that the component 1362 may be written in any one of a different variety of programming languages such as, for example, Java. The particular forms, programming languages, and division of labor between components of 1370 should not be construed as a limitation of the techniques described herein. Processing performed by element 1362 may include processing as described elsewhere herein with reference to element 522 of FIG. 10 for subject record generation using an existing template. Element 714 and its use in performing a portion of the processing associated with template and subject record generation is described in more detail elsewhere herein, for example in connection with FIG. 16 and the correlated searching techniques.

The processing steps described herein in connection with generating a subject record and template in an embodiment will now be summarized.

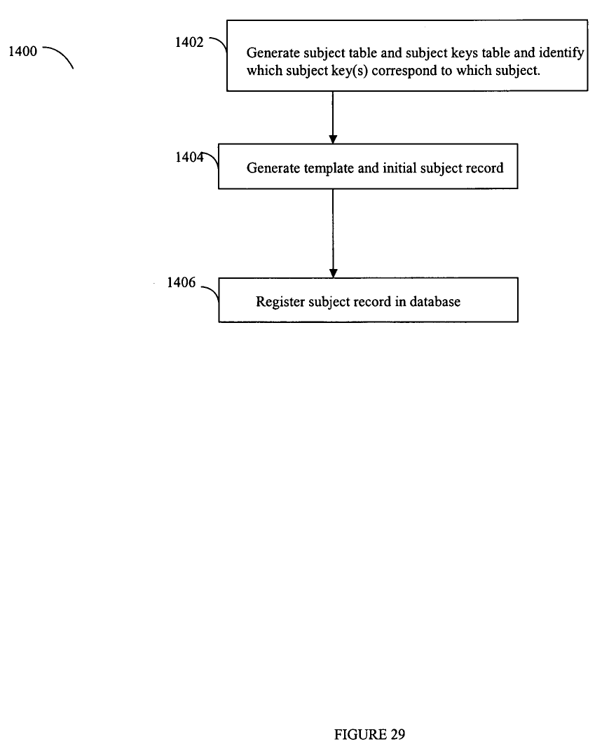

Referring now to FIG. 29, shown is a flowchart 400 of high level processing steps that may be performed in an embodiment of the system of FIG. 1. At step 1402, the subject table and subject keys table are generated and populated with data. Additionally, each entry included in the subject table is associated with one or more subject keys from the subject keys table. It should be noted that in an embodiment, the processing associated with step 1402 may be performed, for example, by an administrator in connection with initially populating particular tables in a database. Step 1404 may be performed at a later point in time using the information from the subject table and the subject keys table as may be, for example, stored in the system database. In connection with step 1404 processing, a template may be generated in conjunction with producing an initial subject record. Processing associated with step 1404 is described in more detail in following paragraphs. At step 1406, the subject record created from step 1404 is registered in the system database. Part of the processing associated with step 1406 is described in more detail with reference to other figures.

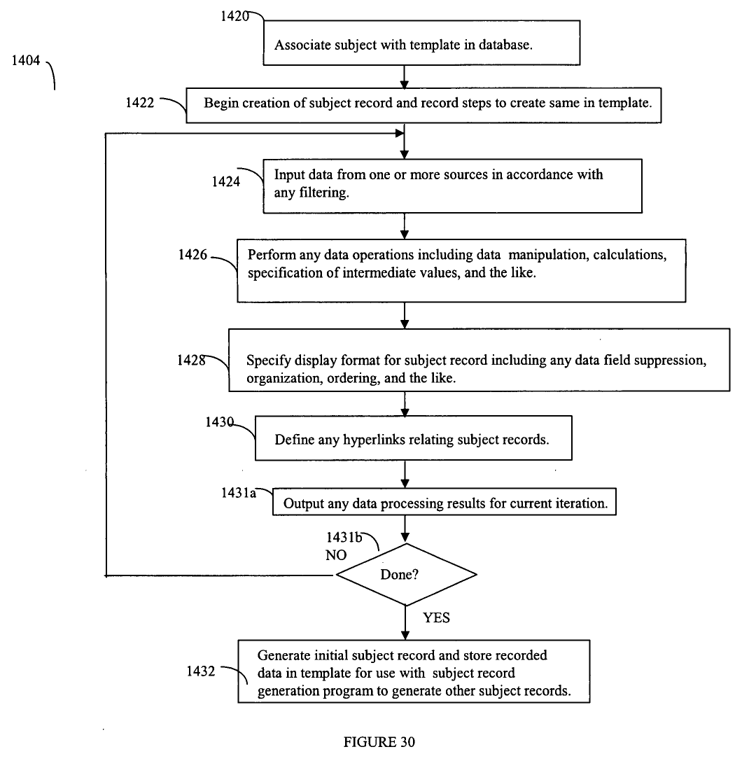

Referring now to FIG. 30, shown is a flowchart with more detailed processing of step 1404 of FIG. 29 for generating a template and an initial subject record. It should be noted that steps included in FIG. 30 are similar to those as described elsewhere herein in connection with the data processing operations such as for correlated searching and obtaining data from one or more data sources as described, for example, in connection with FIGS. 18 and 19. At step 1420, a subject is associated with a template in the system database. At step 1422, creation of a subject record may be commenced and following steps that will be performed by the user in connection with creation of the subject record may be recorded. A template may be created as a result of executing the steps of flowchart 1404 and recording any steps in connection with creation of the subject record. The particular steps taken in connection with the creation of a subject record may vary in accordance with each embodiment and each particular subject record created. What will be described in following steps generalize some of the processing that may be performed in an embodiment in connection the particular functionality that may be included in an embodiment. At step 1424, data may be input from one or more sources in accordance with any filtering performed on the data. At step 1426, data operations may be performed on the data input at step 1424. Data operations may include, for example, data manipulation, calculations, specification of intermediate values, and the like. At step 1428, the display format for a resulting subject record may be specified. Specifying the display format may include, for example, specifying what particular data fields or columns may be suppressed or displayed, specifying a particular organization of rows and/or columns, specifying any particular ordering of the resulting data included in the subject record, and the like. At step 1430, any hyperlinks may be defined relating the current subject record to one or more other subject records. Processing associated with step 1430 is described in more detail elsewhere herein. Additionally, actions which are performed at run time, for example, when a user selects a hyperlink in a displayed subject record are also described in more detail elsewhere herein with the subject search engine. Control proceeds to step 431 a to output any results from the current iteration. Recall, for example, in connection with FIGS. 18 and 19, multiple iterations may be performed in which each iteration may produce a set of results such as query results. Execution of processing for an nth iteration may make reference to any previous iteration results for iterations 1 through n-1. At step 431b, a determination is made as to whether processing is complete for all iterations. If so, control proceeds to step 432. Otherwise, control proceeds to step 424 to continue with the next iteration of data processing. At step 432, the initial subject record is generated. Additionally, the data recorded during the creation of the subject record may be stored in a template for use in connection generation of other subject records with the subject record generation program. As described elsewhere herein, the data stored in the template may be used as input by one or more other software components such as the subject record generation program which may utilize the information in the template in connection with generating one or more subject records at one or more other points in time. Particular examples as to when subject records may be generated are described elsewhere herein, for example, in connection with a scheduler.

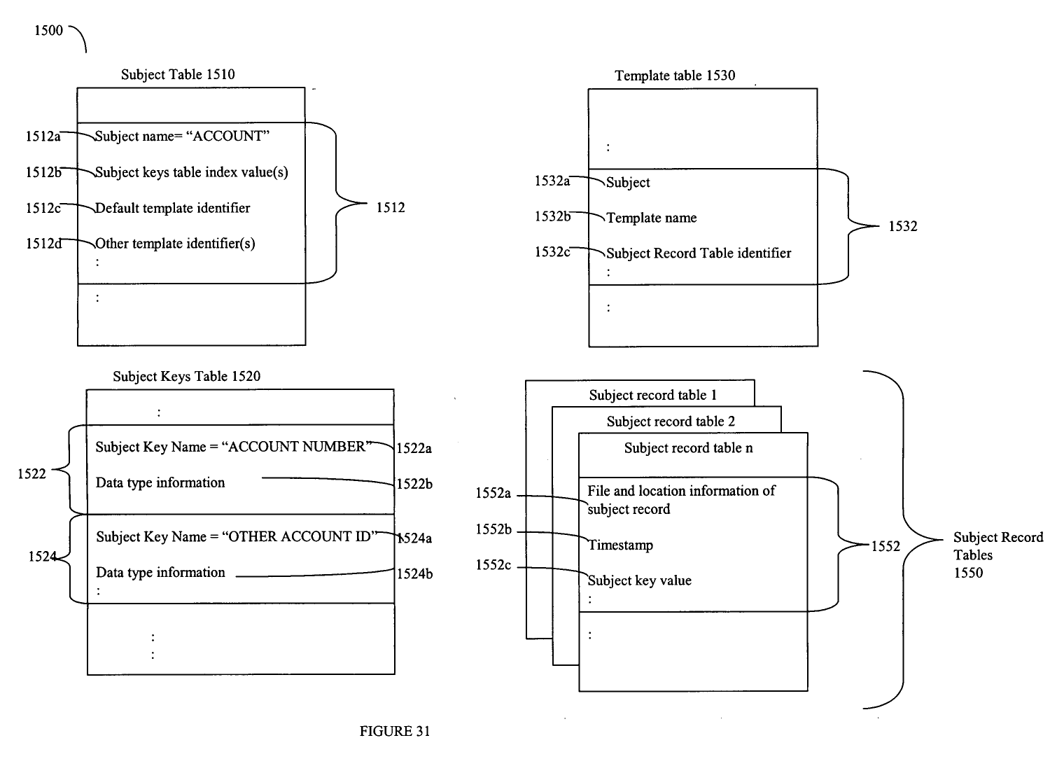

Referring now to FIG. 31, shown is an example 1500 of structures that may be included within the system database 1378 of FIG. 28. Included in the example 1500 is a more detailed description of data that may be included in a subject table 1510, a template table 1530, a subject keys table 1520, and subject record tables 1550. The subject table 1510 may include one or more entries. An entry 1512 within the table 1510 is illustrated as including fields 1512a through d. A record within the subject table 1510 may include a subject name 1512a, one or more index values 1512b into the subject keys table 1520, a default template identifier 1512c, and other template identifiers 1512d. It should be noted that field 1512b may include one or more index values in which each of the index values corresponds to a unique entry within the subject keys table 1520. Field 1512d may be null if only a single template identifier is identified.

It should be noted that in connection with each of the data records and tables described herein, an embodiment may include different information organized in any one of a variety of different ways than as illustrated in the example 1500. This may vary in accordance with each embodiment and how the information used in connection with the techniques described herein may be stored.

The subject keys table 1520 in this example includes a first record 1522 and a second record 1524. Each of the entries (e.g., 1522, 1524) of 1520 includes a subject key name (e.g., 1522a and 1524a) and data type information (e.g., 1522b and 1524b). As an example, if entry 1512 has a subject name=“ACCOUNT”, meaning that the subject corresponds to account information, field 1512b may include two index values corresponding to entries 1522 and 1524 within the subject keys table 1520. Record 1522 may represent an “ACCOUNT NUMBER”. Record 1524 may represent another key or other information, “OTHER ACCOUNT ID”, by which a particular account may be identified. It should be noted that there should be at least one entry within the subject keys table 1520 for each entry within the subject table 1510.

The template table 1530 includes an entry for each template created. A single template table entry is described in more detail as illustrated by 1532 and includes a subject 1532a, a template name 1532b, and a subject record table identifier 1532c. Field 1532a includes information identifying a particular entry within the subject table 1510 with which this particular template entry 1532 is associated. Field 1532b identifies the name of this particular template. It should be noted that for a particular subject, the template name should be unique. In other words, a single subject may be associated with one or more templates. Therefore, the template name field 1532b is used uniquely to identify a particular entry within the template table 1530 from other templates associated with the same subject. Entry 1532c includes an identifier for one of the subject record tables 1550. In this embodiment, subject records associated with each particular template are organized in corresponding subject record table. Within each particular subject record table of 1550, such as subject record table n, one or more entries may be included. A single entry 1552 within a subject record table is illustrated in more detail and may include file and location information of a particular instance of a subject record 1522a, time stamp information 1522b, and a subject key value 1522c associated with this particular subject record. Field 1522a may identify, for example, the location and file name of a particular subject record which is described elsewhere herein corresponds to an instance of a particular template. The time stamp 1522b represents date and/or time information associated with when this particular subject record was generated. The subject key value 1552c identifies the particular value or instance of a subject key associated with this particular record. For example, if subject record table n is associated with a template corresponding to a subject=“ACCOUNT” with a subject key=“ACCOUNT NUMBER”, the instance of the subject key is the particular value of the ACCOUNT NUMBER for the subject record. The subject key value in 1552c may be, for example, a numeric or integer representing an instance of an ACCOUNT NUMBER (e.g., an instance of subject key entry 1522). In the event that a subject, such as ACCOUNT, may be associated with more than a single subject key from 1520, other subject records of the same subject record table (e.g., subject record table n) may then include instances 1522c corresponding to other subject key entries, such as for “OTHER ACCOUNT ID”. As another example, if a subject name=“employee”, an employee may be identified by an employee number, a name, or a social security number. For an entry in subject table 1510 corresponding to “employee”, three entries in the subject keys table 1520 may be defined corresponding each “employee number”, “name” and “social security number”. If a template is generated and associated with the subject=“employee”, a corresponding subject record table for the template associated with “employee” may include entries having subject key values for any of “employee number”, “name”, or “social security number”.

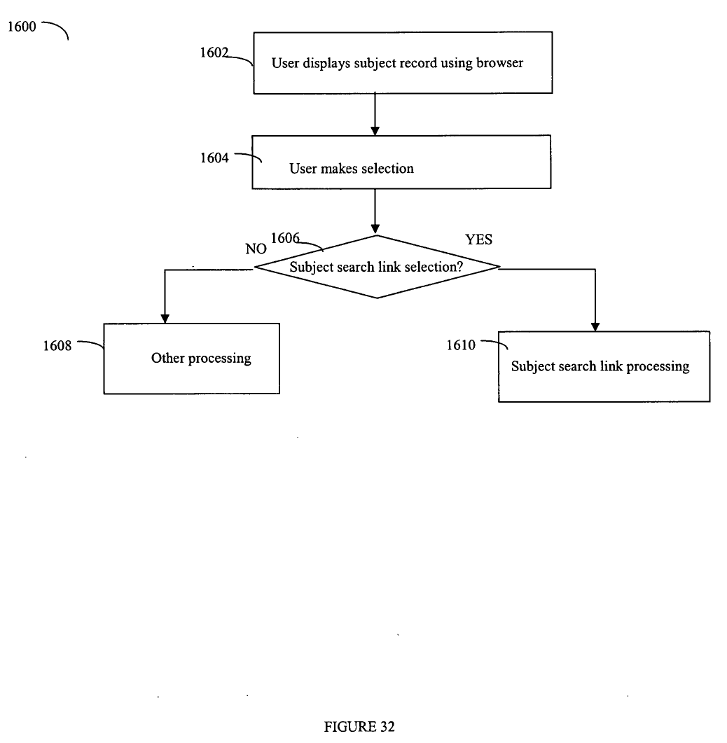

Referring now to FIG. 32, shown is a flowchart 1600 of processing steps that may be performed in an embodiment in connection with a user displaying an HTML file corresponding to a subject record. At step 1602, the user may display the subject record that is represented, for example, as an HTML file using a browser. At step 1604, the user may make a selection of an element within the displayed page for the subject record. At step 1606, a determination is made as to whether a selection has been made for a subject search link. If not, control proceeds to step 1608 to perform other processing. Otherwise, if a subject search link selection has been made such as, for example, by selection of a hyperlink corresponding to a subject search link, control proceeds to step 1610 to perform subject search link processing. The processing at step 1610 is performed, for example, upon selection by a user of a subject search link which has been previously created, such as in connection with step 1430 processing relating a first instance of a subject record to another instance of a related subject record.

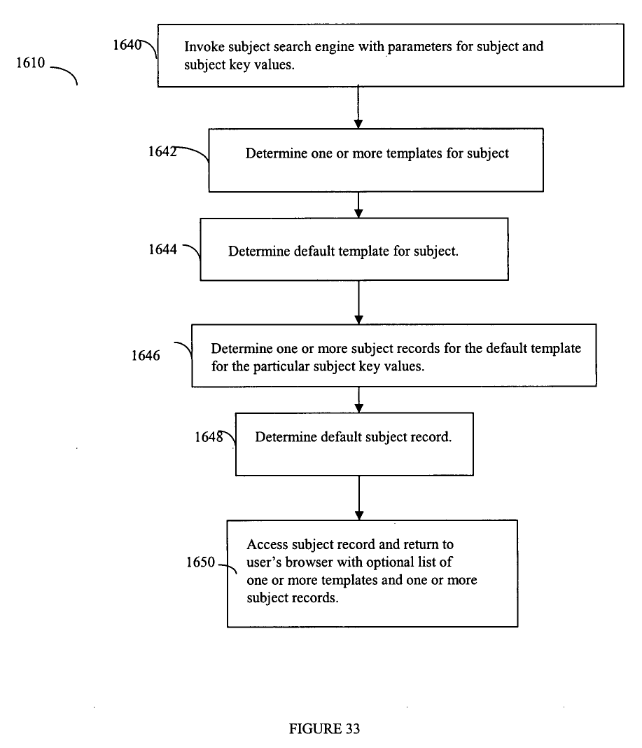

Referring now to FIG. 33, shown is a flowchart 1610 of processing steps that may be performed in an embodiment in connection with subject search link processing. The steps of the flowchart of FIG. 33 describe in more detail the processing step 1610 previously referenced in flowchart 1600. At step 1640, the subject search engine may be invoked with parameters corresponding to a particular subject and subject key values. The search engine may be invoked by a page that is referenced in accordance with the URL of the subject search link which, in one embodiment, corresponds to the hyperlink defined and described elsewhere herein. The call invoking the page passes the subject type and subject key values as a parameters to the page. Within the page invoked by the URL are commands which invoke the subject search engine as described at step 1640. The processing steps of the remaining steps of flowchart 1610 may be performed by the subject search engine after invocation. At step 1642, one or more templates for the subject passed as a parameter in step 640 are determined. The subject search engine may perform this processing by examining information within the system database, such as the tables previously described in connection with FIG. 32. To determine the particular template associated with the subject parameter, the subject table 1510 may be examined and the one or more templates may be determined, for example, in accordance with values that may be included in fields 1512c and 1512d for that particular subject. At step 1644, a default template for that particular subject may be determined. It should be noted that in this particular embodiment, step 1642 may determine and retain information about templates other than the default template. This is an optional feature. In this particular example, the one or more templates that may be associated with a particular subject may used in connection with subsequent processing steps. At step 1646, one or more subject records for the default template having the particular subject key values also passed as a parameter are determined. Processing of step 1646 may be performed, for example, by the subject search engine using tables described in connection with 1500 of FIG. 31. The particular entry 1532 within the table 1530 for the default template is determined. Using the value in field 1532c of this particular entry, the appropriate subject record table may be identified. Entries within that particular subject record table are determined for a given subject key value (e.g., passed as a parameter to the subject search engine invocation at step 1640). In the event that there is more than one subject record as a result of step 1646 processing, a default subject record may be determined. In one embodiment, the default subject record determined at step 1648 may be determined in accordance with each subject record's time stamp value such that, for example, the most recent subject record may be selected as the default subject record.

At step 1650, the default subject record is returned to the user for display with the user's browser. Additionally, an embodiment may also return an optional list of one or more templates determined, for example, at step 1642. An embodiment may also optionally return a list representing one or more other subject records, for example, determined at step 1646 in addition to the default subject record. The list of templates and/or the list of one or more other subject records may include a particular name or other identifier associated with each of the templates and subject records. Each of these optional lists of templates and/or subject records may be displayed to the user through their browser as a drop down list in connection with the default subject record. The user may then make a selection from one of these displayed drop down lists. For example, subject records may be created at various points in time representing different reports generated. The most recent report may be returned as the subject record at step 1650. Additionally, if other reports corresponding to different subject records generated at prior points in time are also included within the database, identifiers corresponding to each of these reports may be returned in the optional list of one or more subject records. A user may directly select one of these other reports from this list. The user's selection for a particular report causes retrieval of a corresponding subject record which is then sent to the user for display in connection with the user's browser. The selected subject record may be passed as a parameter to the subject search engine.

In an embodiment, it may be that one or more templates in additional to a default template have been defined and associated with a particular subject. It is the one or more additional templates (e.g., other than the default template), or portion thereof, that may be displayed in the drop down list. In connection with the optional drop down list of templates, a user may then make a template selection which results in display of a default subject record for the template selection. As an example, a subject record may exist for an employee (subject=“employee”). The subject record may correspond to a default template defined for subject=“employee”. The default template may include basic employee information such as name, social security number, address, and the like. The default template may correspond to a human resource department master form. A second additional template may also be defined and associated with the subject=“employee”. The second template may result in display of a subject record including payroll information for a current time period also associated with a particular employee. Thus, what may be returned at step 1650 as the default subject record is the human resource master form instance corresponding to a particular employee. However, if the user wishes to examine payroll or other information that may also be defined for this particular employee, the user may then make an appropriate selection for the payroll information template from the template drop down list. If the user selects the payroll information template, the subject search engine is again invoked to process this subsequent template selection. In connection with this subsequent invocation of the subject search engine, the subject search engine is passed parameters including the subject and subject key values, as described previously in step 1640 processing, and also another parameter identifying the particular template selection. In accordance with the particular template selection, the subject search engine may then access a corresponding entry in the template table 1530. Using this corresponding entry in the template table 1530, the appropriate subject record table may be determined and used to access a corresponding subject record table. The subject record table may then be queried in accordance with the subject key value parameters as described previously, for example, in connection with steps 1646 and 1648 processing of FIG. 33. In other words, the processing performed by the subject search engine in response to a user selecting a template from the optional template drop down list (e.g., resulting from step 1650) is similar to processing steps as described in connection with invocation of the subject search engine at step 1640 with an additional difference. The difference is that the subject search engine invoked in response to selection of a template from the dropdown list is also passed a third parameter corresponding to the template selection. The subject search engine then uses the template selection passed as a parameter in connection with performing step 1646 processing rather than determining and using a value for a default template.

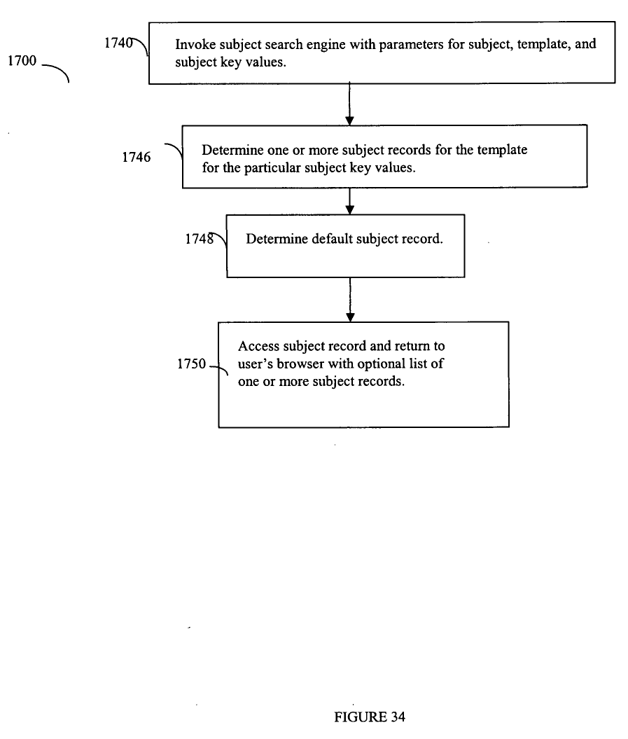

Referring now to FIG. 34, shown is a flowchart 1700 of processing steps that may be performed in an embodiment in connection with processing a selection from a template drop down list. The template drop down list may be included as return value in connection with step 1650 processing. Flowchart 1700 summarizes the processing steps just described above. At step 1740, the subject search engine is invoked and passed as values for the following input parameters: subject, template selection, and subject key(s). At step 1746, one or more subject records are determined for the selected template and associated subject key(s) passed as input parameters. At step 1748, a default subject record is determined if more than one subject record was determined for the particular template. At step 1750, the subject record is accessed and returned to the user's browser. Additionally, an optional list of the one or more subject records determines at step 1746 may also be returned.

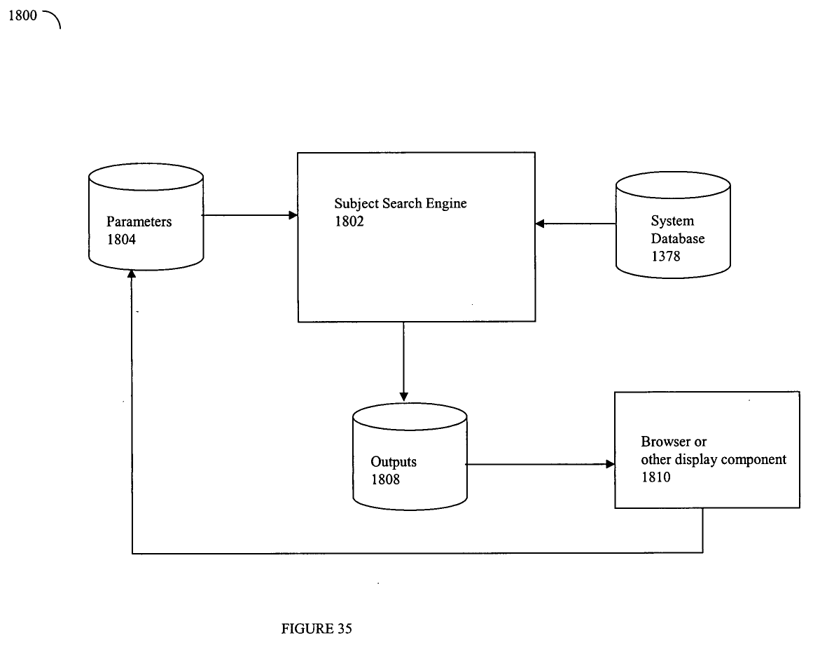

Referring now to FIG. 35, shown is an example 1800 illustrating the data flow between components in connection with performing the techniques described herein upon hyperlink selection from a displayed subject record. As described above, hyperlink selection causes a invocation of the subject search engine 1802. The engine 1802 is passed parameters 1804, such as values for the subject and subject keys. The engine 1802 then performs processing to retrieve information from the database in accordance the parameters 1804. The engine 1802 formulates one or more output elements to be returned to the user for display by component 1810. The outputs may include a selected subject record. Additionally, the outputs may include a list of subject records, and a list of templates. The user may make another selection causing a subsequent invocation of the engine 1802. The user may select another hyperlink or make a selection from one of the drop down lists. In the event that a selection is made from the template drop down list, three parameters are passed to the engine 1802 for a subject, subject key(s) and the template selection. In the event that a selection is made from the subject drop down list, the selected subject record may be passed as an input parameter in addition to values for the subject and subject keys.

It should be noted that an embodiment which returns one or more of the drop down lists may display the list in a separate frame within a browser. Alternatively, the list data may be embedded within the returned form or other data resulting in display of the subject record.

While the invention has been disclosed in connection with preferred embodiments shown and described in detail, their modifications and improvements thereon will become readily apparent to those skilled in the art. Accordingly, the spirit and scope of the present invention should be limited only by the following claims.

1. A method for automatically performing data operations comprising:
receiving a request and one of a template or an identifier for said template, said template specifying at least a first set of previously recorded data and a second set of previously recorded data, said first set of previously recorded data describing a first data source, first operation data, and first result structure data, said first operation data describing at least one criterion used in performing a first data operation on said first data source and producing first results in accordance with said first result structure data, said second set of previously recorded data describing a second data source, second operation data, and second result structure data, said second operation data being used in performing a second data operation on said second data source and producing second results in accordance with said second result structure data, wherein said second operation data specifies a data element included in said first results, said second results being dependent upon said first results; and
in response to receiving said request, performing processing operations in accordance with said template producing final results in accordance with at least one of said first results and said second results.

2. The method of claim 1, further comprising:
saving said first results and second results as an aggregate result, wherein said aggregate result comprises two data tables included in an XML file.

3. The method of claim 1, wherein at least one of said first data operation and said second data operation uses a software application to access, respectively, one of said first data source and said second data source.

4. The method of claim 1, wherein said performing processing operations is performed by a query formulator engine, and the method further comprising:
invoking said query formulator passing one of said template, or an identifier of said template, as a parameter.

5. The method of claim 4, wherein said invoking is performed in accordance with a scheduled operation by a scheduler making said request.

6. The method of claim 1, wherein said first data operation is different from said second data operation.

7. The method of claim 6, wherein said first data operation is a first query, said first operation data specifies search criteria used in performing said first query and producing said first results in accordance with results of said first query, said second data operation is a second query, said second operation data specifying search criteria used in performing said second query and producing said second results in accordance with results of said second query.

8. The method of claim 1, wherein said final results includes data based on at least two of: said first data source, said second data source, said first results and said second results.

9. The method of claim 1, wherein said template includes a computation operating on data from at least one of said first results and said second results.

10. The method of claim 4, wherein further comprising:
accessing at least one of said first and said second data sources using an adaptor, said adaptor:
invoking an application to access said at least one of said first and second data sources; and
performing any data mapping to facilitate interfacing between said application and said query engine.

11. The method of claim 1, wherein said first data source and said second data source are disparate data source types.

12. The method of claim 11, wherein at least one of said first data source and said second data source is a structured data source and the other of said data sources is one of: an unstructured data source or a software application management system for unstructured content.

13. The method of claim 1, further comprising:
recording said first set of previously recorded data and said second set of previously recorded data during creating of a first subject record including a collection of data about a subject.

14. The method of claim 10, further comprising:
performing processing to place said first results in a format in accordance with said first result structure data and to place said second results in a format in accordance with said second result structure data;
aggregating said first results and said second results in accordance with said formats in a result pool;
passing the result pool to a component.

15. The method of claim 14, wherein said component caused said invoking of said query engine.

16. The method of claim 14, wherein said result pool is one of: an XML stream, a set of database tables or a file which is passed to an application for further processing to produce said final results.

17. The method of claim 2, wherein said template includes “n” previously recorded data sets, “n” being greater than two, each of said “n” previously recorded data sets including information describing an “nth” data source, “nth” operation data, and “nth” result structure data, said “nth” operation data being used in performing an “nth” data operation on said “nth” data source and producing “nth” results in accordance with said “nth” result structure data, wherein said “nth” operation data specifies a data element included from a results associated with any one of said “n-1” previously recorded data sets.

18. A system comprising:
a template specifying at least a first set of previously recorded data and a second set of previously recorded data, said first set of previously recorded data describing a first data source, first operation data, and first result structure data, said first operation data describing at least one criterion used in performing a first data operation on said first data source and producing first results in accordance with said first result structure data, said second set of previously recorded data describing a second data source, second operation data, and second result structure data, said second operation data being used in performing a second data operation on said second data source and producing second results in accordance with said second result structure data, wherein said second operation data specifies a data element included in said first results, said second results being dependent upon said first results;
a requester issuing a request including said template or an identifier for said template; and
a query formulator engine which receives said request and, in response, performs processing operations in accordance with said template producing final results in accordance with at least one of said first results and said second results.

19. The system of claim 18, further comprising:
an adapter for each of said first and said second data sources to facilitate obtaining data from each of said data sources.

20. A method for automatically performing data operations comprising:
recording a first set of recorded data for a first query performed on a first data source producing first results;
recording a second set of recorded data for a second query performed on a second data source producing second results, said second query including a query term which is dependent on a data element included in said first results, said second set of recorded data including a reference to said data element in said first results;
producing first final results in accordance with at least one of said first results and said second results; and
saving said first set of recorded data and said second set of recorded data in a template, said template being used in connection with reperforming said first and second queries on current instances of said data sources at a later point in time producing second final results in response to a single request.

21. A computer program product for automatically performing data operations comprising code that:
receives a request and one of a template or an identifier for said template, said template specifying at least a first set of previously recorded data and a second set of previously recorded data, said first set of previously recorded data describing a first data source, first operation data, and first result structure data, said first operation data describing at least one criterion used in performing a first data operation on said first data source and producing first results in accordance with said first result structure data, said second set of previously recorded data describing a second data source, second operation data, and second result structure data, said second operation data being used in performing a second data operation on said second data source and producing second results in accordance with said second result structure data, wherein said second operation data specifies a data element included in said first results, said second results being dependent upon said first results; and
in response to receiving said request, performs processing operations in accordance with said template producing final results in accordance with at least one of said first results and said second results.

22. A computer program product for automatically performing data operations comprising code that:
records a first set of recorded data for a first query performed on a first data source producing first results;
records a second set of recorded data for a second query performed on a second data source producing second results, said second query including a query term which is dependent on a data element included in said first results, said second set of recorded data including a reference to said data element in said first results;
produces first final results in accordance with at least one of said first results and said second results; and
saves said first set of recorded data and said second set of recorded data in a template, said template being used in connection with reperforming said first and second queries on current instances of said data sources at a later point in time producing second final results in response to a single request.
